(19) United States
(12) Patent Application Publication
(10) Pub. No.: US 2024/0353654 A1
(43) Pub. Date: Oct. 24, 2024

(54) OPTICAL SYSTEM AND CAMERA MODULE COMPRISING SAME

(71) Applicant: LG INNOTEK CO., LTD., Seoul (KR)

(72) Inventor: Ju Yong SHIM, Seoul (KR)

(21) Appl. No.: 18/683,092

(22) PCT Filed: Aug. 10, 2022
(86) PCT No.: PCT/KR2022/011954

§ 371 Date: Feb. 12, 2024

(30) Foreign Application Priority Data
Aug. 10, 2021 (KR) 10-2021-0105668

(51) Int. Cl. G02B 13/00; G02B 3/00; G02B 13/18

(52) U.S. Cl. CPC G02B 13/0045; G02B 13/18; G02B 2003/0093

(57) ABSTRACT

The optical system disclosed in the embodiment of the invention includes first to fourth lens groups disposed along an optical axis in a direction from an object side to a sensor side and including at least one lens, respectively, wherein the first lens group and the fourth lens group have opposite refractive powers, the second lens group and the third lens group have opposite refractive powers, positions of the first and fourth lens groups are fixed, and a position of each of the second and third lens groups is movable in a direction of the optical axis, wherein the optical system having the first to fourth lens groups is operated with magnifications according to changes in at least three modes according to a movement of each of the second lens group and the third lens group, and the following equation may satisfy: TTL/EPD_Tele<2.72, wherein TTL is a distance from the optical axis to a surface of an image sensor and a lens surface closest to the object side among lenses of the first lens group, and EPD_Tele is a size of an entrance pupil diameter (EPD) of the optical system when operating at the highest magnification in an operation mode.

### TECHNICAL FIELD

An embodiment relates to an optical system for improved optical performance and a camera module including the same.

### BACKGROUND ART

The camera module captures an object and stores it as an image or video, and is installed in various applications. In particular, the camera module is produced in a very small size and is applied to not only portable devices such as smartphones, tablet PCs, and laptops, but also drones and vehicles to provide various functions. For example, the optical system of the camera module may include an imaging lens for forming an image, and an image sensor for converting the formed image into an electrical signal. In this case, the camera module may perform an autofocus (AF) function of aligning the focal lengths of the lenses by automatically adjusting the distance between the image sensor and the imaging lens, and may perform a zooning function of zooming up or zooning out by increasing or decreasing the magnification of a remote object through a zoom lens. In addition, the camera module employs an image stabilization (IS) technology to correct or prevent image stabilization due to an unstable fixing device or a camera movement caused by a user's movement.

The most important element for this camera module to obtain an image is an imaging lens that forms an image. Recently, interest in high efficiency such as high image quality and high resolution is increasing, and research on an optical system including plurality of lenses is being conducted in order to realize this. For example, research using a plurality of imaging lenses having positive (+) and/or negative (−) refractive power to implement a high-efficiency optical system is being conducted. However, when a plurality of lenses is included, there is a problem in that it is difficult to derive excellent optical properties and aberration properties. In addition, when a plurality of lenses is included, the overall length, height, etc. may increase due to the thickness, interval, size, etc. of the plurality of lenses, thereby increasing the overall size of the module including the plurality of lenses.

The size of the image sensor is increasing to realize high-resolution and high-definition. However, when the size of the image sensor increases, the TTL (Total Track Length) of the optical system including the plurality of lenses also increases, thereby increasing the thickness of the camera and the mobile terminal including the optical system. When the optical system includes a plurality of lenses, a zoom, autofocus (AF) function, etc. may be performed by controlling the position of at least one lens or a lens group including at least one lens. However, when the lens or the lens group performs the above function, the movement amount of the lens or the lens group may increase exponentially. Accordingly, the optical system may require a lot of energy for movement of the lens or the lens group, and there is a problem that a large volume is required in consideration of the amount of movement. In addition, when the lens or the lens group is moved, there is a problem in that aberration characteristics according to the movement are deteriorated. Accordingly, there is a problem in that optical characteristics are deteriorated at a specific magnification when zoom and autofocus (AF) functions are performed. Therefore, a new optical system capable of solving the above problems is required.

### DISCLOSURE

### Technical Problem

The embodiment provides an optical system with improved optical properties. The embodiment provides an optical system and a camera module capable of photographing at various magnifications. The embodiment provides an optical system and a camera module having improved aberration characteristics at various magnifications. The Embodiment provides an optical system and a camera module that may be implemented in a small and compact.

### Technical Solution

An optical system according to an embodiment of the invention comprises first to fourth lens groups disposed along an optical axis in a direction from an object side to a sensor side and including at least one lens, respectively, wherein the first lens group and the fourth lens group have opposite refractive powers, the second lens group and the third lens group have opposite refractive powers, positions of the first and fourth lens groups are fixed, and a position of each of the second and third lens groups is movable in a direction of the optical axis, wherein the optical system having the first to fourth lens groups is operated with magnifications according to changes in at least three modes according to a movement of each of the second lens group and the third lens group, a distance in the optical axis from a lens surface closest to the object side among lenses of the first lens group to a surface of an image sensor is TTL, a size of an entrance pupil diameter (EPD) of the optical system when operating at the highest magnification in an operation mode is EPD_Tele, and the following equation may satisfy: TTL/EPD_Tele<2.72.

According to an embodiment of the invention, the first lens group includes first to third lenses sequentially disposed along the optical axis from the object side toward the sensor side, the second lens group includes fourth and fifth lenses sequentially arranged along the optical axis from the object side toward the sensor side, the third lens group includes sixth and seventh lenses sequentially arranged along the optical axis from the object side toward the sensor side, and the fourth lens group may include an eighth lens.

According to an embodiment of the invention, the first lens group has a negative (−) refractive power, the first lens has a positive (+) refractive power, the third lens has a negative (−) refractive power, and the fourth lens may have positive (+) refractive power.

According to an embodiment of the invention, the third lens may be formed of a glass material having an aspherical surface and have a refractive index of 1.75 or more, and the fourth lens may be formed of a glass material having an aspherical surface.

According to an embodiment of the invention, an object-side surface of the first lens may have a convex shape on the optical axis toward the object side, and an object-side surface of the fourth lens may have a convex shape on the optical axis toward the object side. An object-side surface of the fifth lens, and an object-side surface and a sensor-side surface of the seventh lens may have at least one inflection point.

According to an embodiment of the invention, a position of the inflection point on the object-side surface of the fifth lens may be arranged in a range of 10% to 30% of an effective radius of the object-side surface of the fifth lens with respect to the optical axis. The eighth lens may have a shape in which the object-side surface and the sensor-side surface do not have inflection points.

An optical system according to an embodiment of the invention comprises: first to fourth lens groups disposed along an optical axis in a direction from an object side to a sensor side and including at least one lens, respectively, wherein a refractive power of the first lens group is opposite to a refractive power of the fourth lens group, a lens closest to the sensor side among the lenses of the first lens group has negative refractive power and is opposite to a refractive power of a lens closest to the object side among the lenses of the second lens group, the positions of the first and fourth lens groups are fixed, the positions of the second and third lens groups are movable in a direction of the optical axis, wherein the optical system having the first to fourth lens groups is operated with magnifications according to changes in at least three modes according to a movement of each of the second lens group and the third lens group, EFL_G1 is an effective focal length of the first lens group, and the following equation may satisfy: EFL_G1<0.

According to an embodiment of the invention, when the second and third lens groups are positioned at a first position, the optical system has a first effective focal length, and when the second and third lens groups are positioned at a second position different from the first position, the optical system has a second effective focal length greater than the first effective focal length.

According to an embodiment of the invention, m_G2 is a movement distance when the second lens group moves from the first position to the second position or from the second position to the first position, TTL (Total track length) is a distance on the optical axis from an object-ide surface of the lens closest to the object in the first lens group to an upper surface of the image sensor, and the following equation may satisfy: 0.05<m_G2/TTL<0.5.

According to an embodiment of the invention, m_G3 is a movement distance when the third lens group moves from the first position to the second position or from the second position to the first position, and TTL (Total Track Length) is a distance on the optical axis from the object-side surface of a lens closest to the object in the first lens group to an upper surface of an image sensor, and the following equation may satisfy: 0.05<m_G3/TTL<0.5.

According to an embodiment of the invention, a maximum movement distance of the third lens group may be greater than a maximum movement distance of the second lens group. The maximum movement distance of the third lens group may be 6 mm or less, and the maximum movement distance of the second lens group may be 5 mm or more.

According to an embodiment of the invention, Min_Relative illumination is a value having a lowest relative illuminance value at each magnification, and the following equation may satisfy:

Min_Relative illumination>40.

According to an embodiment of the invention, CRA is a chief ray incidence angle of light incident to an image sensor, and the following equation may satisfy: CRA<6.

According to an embodiment of the invention, the fourth lens group consists of one lens, the first, third, and fourth lens groups consist of two or more lenses, and CA_L4S7 is an effective diameter of an object-side surface of the fourth lens, CA_L1S1 is an effective diameter of an object-side surface of the first lens, and the following equation may satisfy: CA_L4S7/CA_L1S1<0.7.

According to an embodiment of the invention, vd4 is an Abbe number of the fourth lens and vd5 is an Abbe number of the fifth lens, vd6 is an Abbe number of the sixth lens, and vd7 is an Abbe number of the seventh lens, and the following equation may satisfy: 20<|vd4-vd5| and 20<|vd6-vd7|.

According to an embodiment of the invention, dG1G4 is a distance between a lens surface closest to the sensor side of the first lens group and a lens surface closest to the object side of the fourth lens group on the optical axis, and TTL is a distance on the optical axis from a lens surface closest to the object side of the first lens group to the upper surface of the image sensor, and the following equation may satisfy: 2<dG1G4/TTL<4.

A camera module according to an embodiment of the invention is a camera module including an optical system and a driving member, wherein the optical system includes the above-described optical system, and the driving member may be driven in a direction of the optical axis with respect to each position of the second and third lens groups.

### Advantageous Effects

The optical system and the camera module according to the embodiment may have various magnifications and may have excellent optical properties when various magnifications are provided. In detail, in the embodiment, the intermediate lens groups among the plurality of lens groups may be provided to be movable, and the moving distance of each of the moving lens groups may be controlled to have various magnifications, and an autofocus (AF) function for the subject may be provided. In the optical system and the camera module according to the embodiment, a plurality of lens groups may correct aberration characteristics or compensate for aberration characteristics changed by movement. Accordingly, the optical system according to the embodiment may minimize or prevent chromatic aberration change and aberration characteristic change occurring when the magnification is changed.

The optical system and the camera module according to the embodiment may control the effective focal length (EFL) by moving only some lens groups among the plurality of lens groups, and may minimize the moving distance of the moving lens groups. Accordingly, the optical system may reduce the moving distance of the lens group moving according to the change of the operation mode, and minimize power consumption required when the lens group is moved. In the optical system, at least one lens included in the fixed lens group and the moving lens group may have a non-circular shape. Accordingly, the optical system may reduce the height of the optical system while maintaining optical performance, and secure a space in which the lens groups disposed between the plurality of lens groups are structurally disposed.

The optical system and the camera module according to the embodiment may adjust the magnification by moving a lens group other than the first lens group adjacent to the subject among the plurality of lens groups. Accordingly, the optical system may have a constant TTL value even when the lens group moves according to a change in magnification. Accordingly, the optical system and the camera module including the same may be provided with a slimmer structure.

### DESCRIPTION OF DRAWINGS

FIG. 1 is a block diagram of an optical system and a camera module having the same according to an embodiment of the invention.

FIG. 2 is an example of changing the optical system of FIG. 1 from the first mode to the second mode.

FIG. 3 is an example of changing the optical system of FIGS. 1 and 2 to the third mode.

FIG. 4 is a configuration having a reflective mirror in the optical system of FIG. 1.

FIG. 5 is a graph showing a relative illumination according to the position of the first to third modes in the camera module according to an embodiment of the invention.

FIG. 6 is a graph of a diffraction MTF in an optical system of a first mode (Wide mode) according to an embodiment of the invention.

FIG. 7 is a graph of a diffraction MTF in an optical system of a second mode (Middle mode) according to an embodiment of the invention.

FIG. 8 is a graph of a diffraction MTF in an optical system of a third mode (Tele mode) according to an embodiment of the invention.

FIG. 9 is a graph showing aberration characteristics in an optical system of a first mode according to an embodiment of the invention.

FIG. 10 is a graph showing aberration characteristics in an optical system of a second mode according to an embodiment of the invention.

FIG. 11 is a graph illustrating aberration characteristics in an optical system of a third mode according to an embodiment of the invention.

FIG. 12 is a diagram illustrating a camera module applied to a mobile terminal according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology. The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component.

In the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element.

A convex surface of the lens may mean that the lens surface of a region corresponding to the optical axis has a convex shape with respect to the optical axis, and a concave surface of the lens means that the lens surface of the region corresponding to the optical axis has a concave shape. In addition, “object-side surface” may refer to the surface of the lens facing the object side with respect to the optical axis, and “sensor-side surface” may refer to the surface of the lens facing the image surface (image sensor) with respect to the optical axis. In addition, a center thickness of the lens may mean a thickness in a direction of the optical axis of the lens on the optical axis. Also, a vertical direction may mean a direction perpendicular to the optical axis, and an end of the lens or the lens surface may mean the end of the effective region of the lens through which the incident light passes. In addition, a size of the effective diameter of the lens surface may have a measurement error of up to +0.4 mm depending on a measurement method or the like.

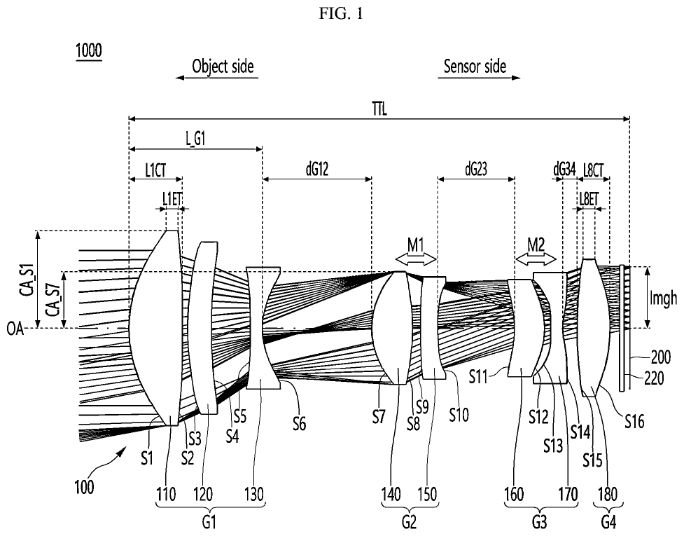

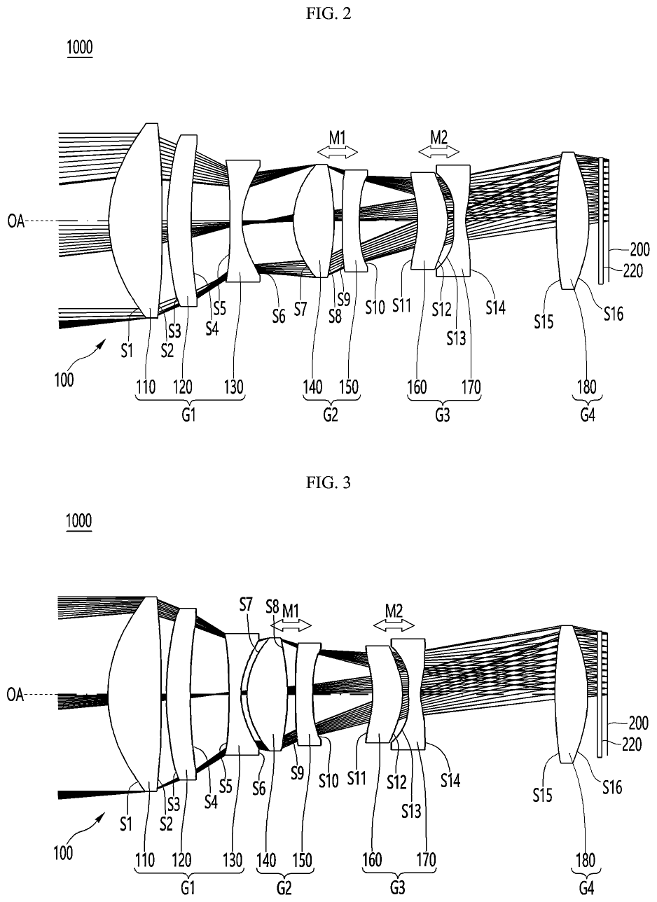

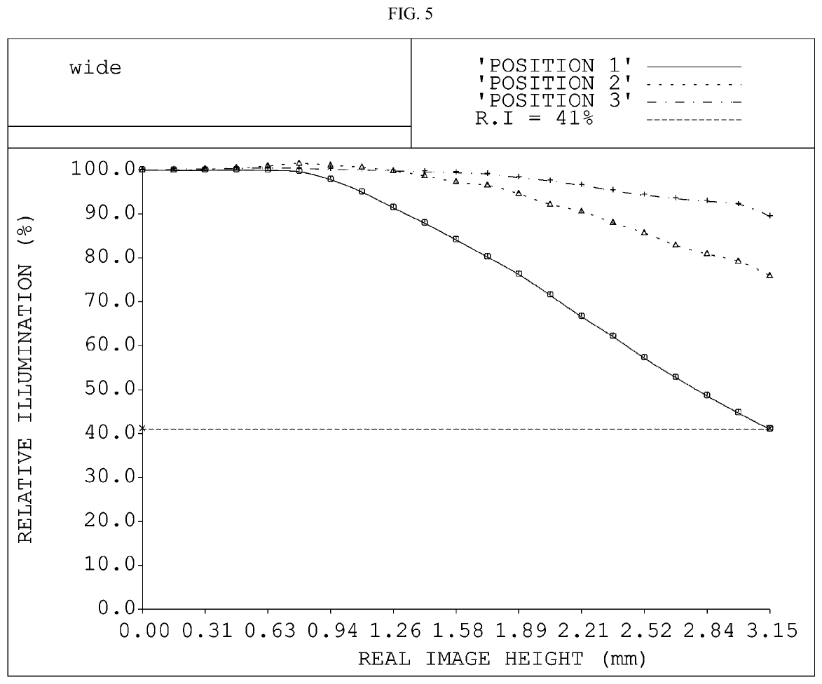

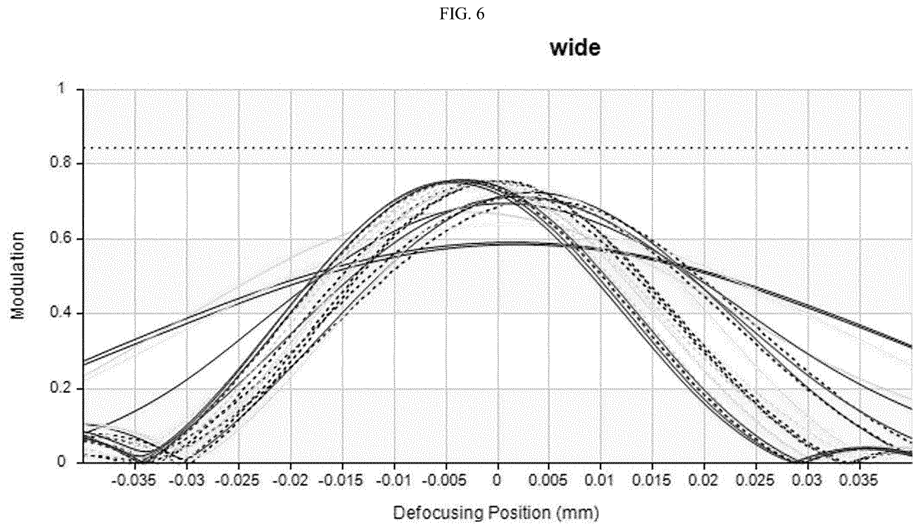

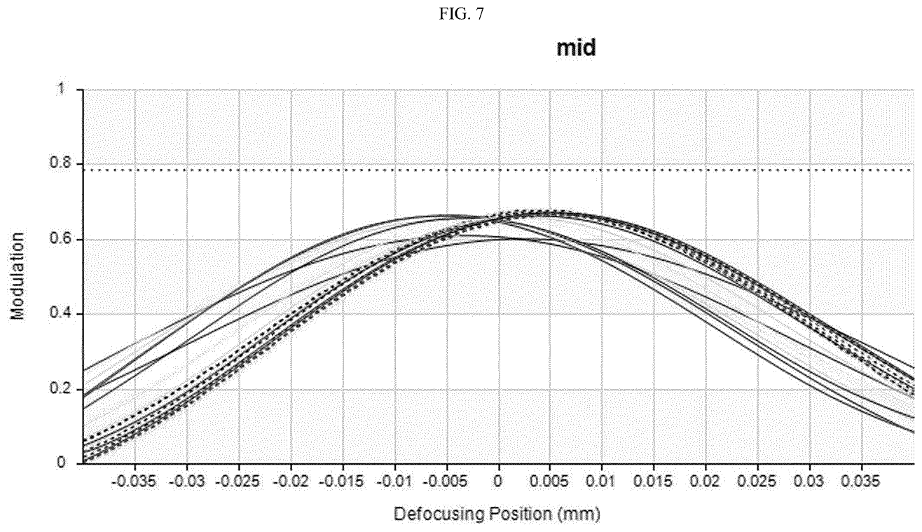

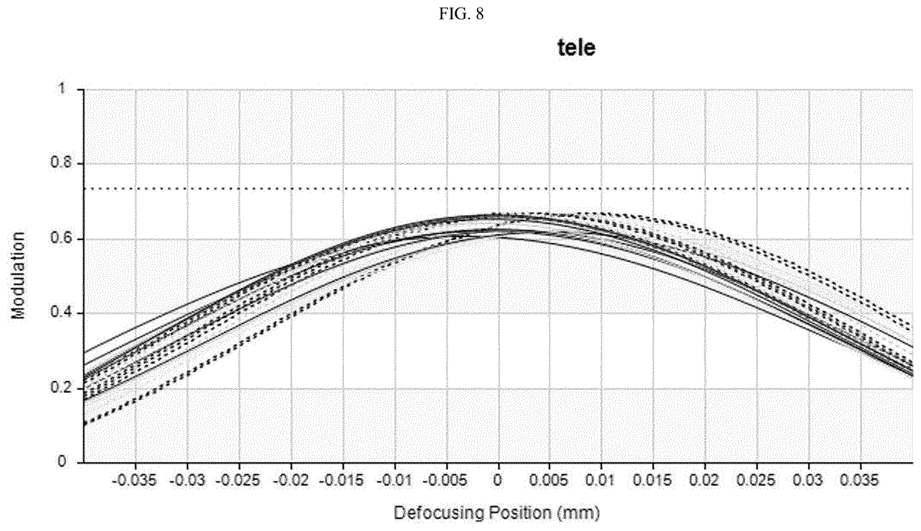

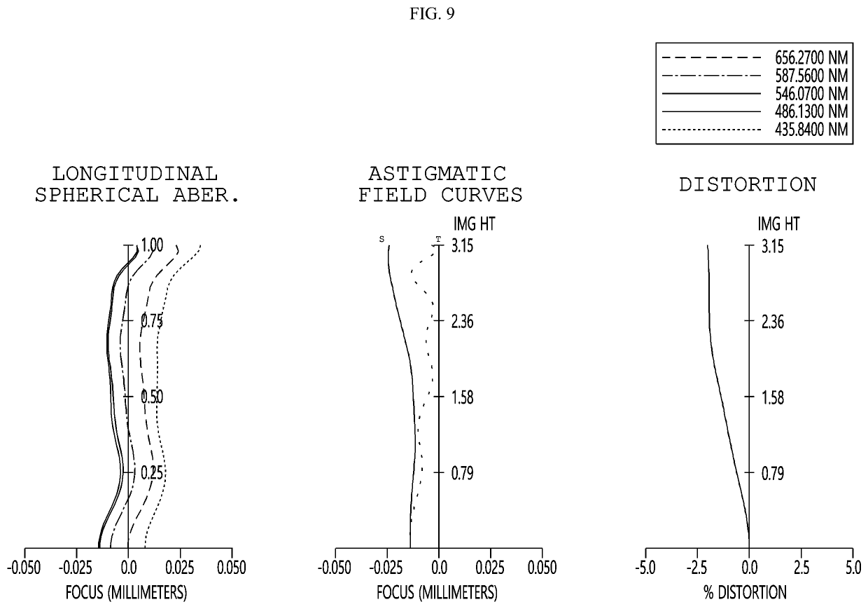

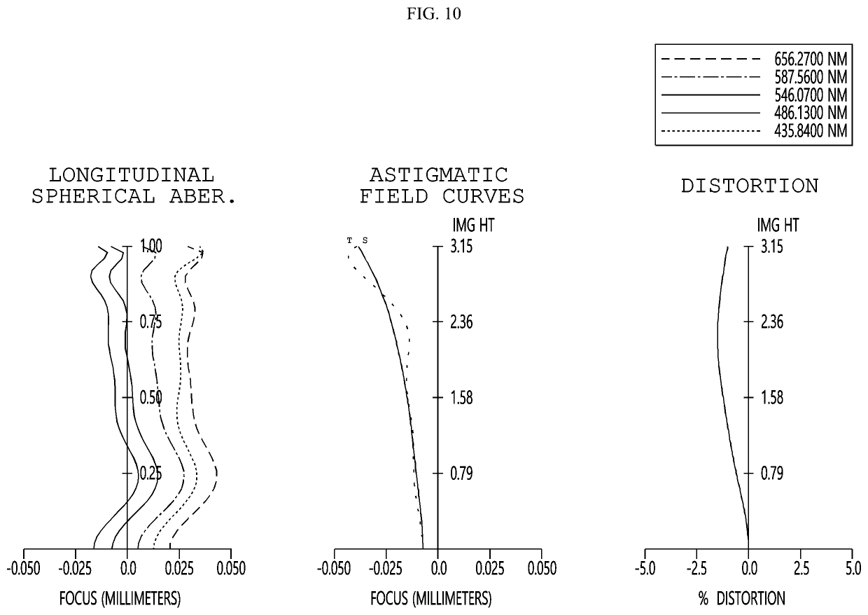

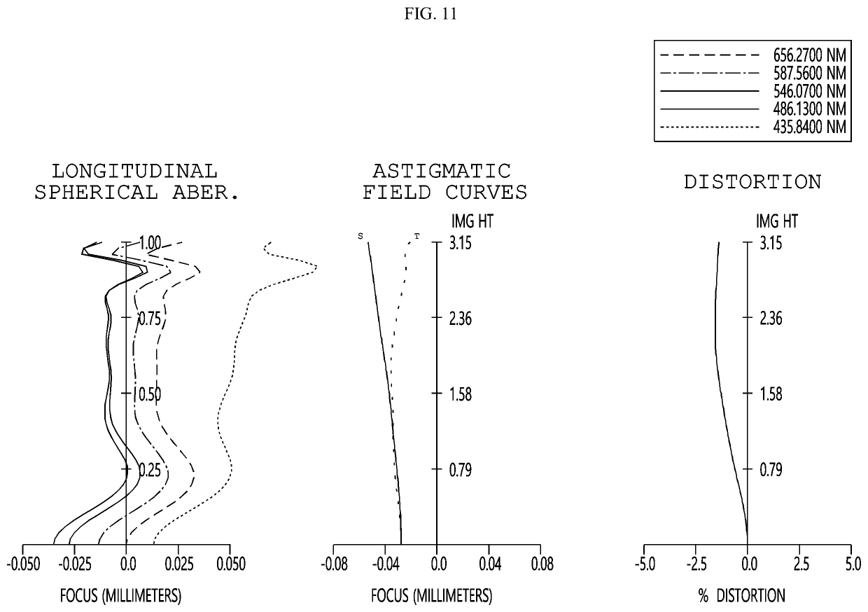

FIG. 1 is a block diagram of an optical system according to an embodiment of the invention, FIG. 2 is an example of a change from the first mode to the second mode of the optical system of FIG. 1, and FIG. 3 is a third mode from the optical system of FIGS. 1 and 2, FIG. 4 is a configuration having a reflective mirror in the optical system of FIG. 1, FIG. 5 is a graph showing the relative illuminance according to the positions of the first to third modes in the camera module according to an embodiment of the invention, FIG. 6 is a graph for diffraction MTF in the optical system of the first mode (Wide mode) according to an embodiment of the invention, FIG. 7 is a graph of the diffraction MTF in the optical system of the second mode (Middle mode) according to an embodiment of the invention, FIG. 8 is a graph of the diffraction MTF in the optical system of the third mode (Tele mode) according to an embodiment of the invention, FIG. 9 is a graph showing the aberration characteristics in the optical system of the first mode according to the embodiment of the invention, FIG. 10 is a graph showing aberration characteristics in an optical system of a second mode according to an embodiment of the invention, and FIG. 11 is a graph showing aberration characteristics in an optical system of a third mode according to an embodiment of the invention.

Referring to FIGS. 1 to 11, the optical system 1000 according to the embodiment may include a plurality of lens groups G1, G2, G3, and G4. In detail, the plurality of lens groups G1, G2, G3, and G4 may include at least two lens groups movable in a direction of the optical axis OA and at least one fixed lens group. The plurality of lens groups G1, G2, G3, and G4 may include a lens group fixed to the object side, a lens group fixed to the sensor side, and a plurality of movable lens group capable of moving between the lens group fixed to the object side and the lens group fixed to the sensor side. The plurality of movable lens groups may include a movable fixed group disposed on the object side and a movable lens group disposed on the sensor side. A lens group fixed to the object side may be defined as a first lens group G1, a lens group movable to the object side may be defined as a second lens group G2, a lens group movable to the sensor side may be defined as a third lens group G3, and a lens group fixed to the sensor side may be defined as a fourth lens group G4.

For example, the optical system 1000 may include a first lens group G1, a second lens group G2, a third lens group G3, and fourth lens group G4 sequentially arranged along the optical axis OA from the object side to the sensor direction. The optical system 1000 may include an image sensor 200 on the sensor side of the fourth lens group G4. The first lens group G1 may include lenses closest to the object side, and the fourth lens group G4 may include lens closest to the sensor side. Each of the first to fourth lens groups G1, G2, G3, and G4 may have positive (+) or negative (−) refractive power. For example, a lens group having a positive refractive power may be at least two lens groups, and a lens group having a negative refractive power may be at least two lens groups.

The first lens group G1 may have a refractive power opposite to that of the second lens group G2. For example, the first lens group G1 may have negative (−) refractive power, and the second lens group G2 may have positive (+) refractive power. The second lens group G2 may have a refractive power opposite to that of the third lens group G3. For example, the second lens group G2 may have positive (+) refractive power, and the third lens group G3 may have negative (−) refractive power. The third lens group G3 may have a refractive power opposite to that of the fourth lens group G4. For example, the third lens group G3 may have negative (−) refractive power, and the fourth lens group G4 may have positive (+) refractive power. A ratio of positive (+) and negative (−) refractive power of the plurality of lens groups G1, G2, G3 and G4 may be 1:1.

The number of lenses in the first lens group G1 may be greater than the number of lenses in the fourth lens group G4. For example, the number of lenses in the first lens group G1 may be greater than the number of lenses in each of the second and third lens groups G2 and G3. The number of lenses of each of the second and third lens groups G2 and G3 may be less than or equal to the number of lenses of the first lens group G1, and may be greater than the number of lenses of the fourth lens group G4. The number of lenses of the first lens group G1 may include at least three lenses for adjusting the amount of incident light, refractive power, and chromatic aberration. The fourth lens group G4 may include at least one lens. For example, the fourth lens group G4 is disposed closest to the image sensor 200, and may have a single lens since a lens for correcting chromatic aberration may be removed.

The first lens group G1 and the second lens group G2 may have different focal lengths. In detail, as the first and second lens groups G1 and G2 have opposite refractive powers, the focal length of the second lens group G2 is opposite to the focal length of the first lens group G1. It can have (+, −). The focal length of the second lens group G2 may have a positive (+) sign, and the focal length of the first lens group G1 may have a negative (−) sign. The refractive power is the reciprocal of the focal length.

The second lens group G2 and the third lens group G3 may have different focal lengths. In detail, as the second and third lens groups G2 and G3 have opposite refractive powers as described above, the focal length of the second lens group G2 may have the opposite sign (+, −) with respect to the focal length of the third lens group G3. For example, the focal length of the second lens group G2 may have a positive sign, and the focal length of the third lens group G3 may have a negative sign.

The third lens group G3 and the fourth lens group G4 may have different focal lengths. In detail, as the third and fourth lens groups G3 and G4 have opposite refractive powers as described above, the focal length of the third lens group G3 may have the opposite sign (+, −) with respect to the focal length of the fourth lens group G4. For example, the focal length of the third lens group G3 may have a positive sign, and the focal length of the fourth lens group G4 may have a negative sign. The absolute values of the focal lengths of each of the first to fourth lens groups G1, G2, G3, and G4 may have a greater value in the order of the first lens group G1, the fourth lens group G4, the third lens group G3, and the second lens group G2.

Since the first lens group G1 and the fourth lens group G4 are fixed in position, and the second lens group G2 and the third lens group G3 are movable in the optical axis OA direction, The optical system may provide various magnifications by moving the lens group.

Hereinafter, the first to fourth lens groups G1, G2, G3, and G4 will be described in more detail. The first lens group G1 may include at least one lens, for example, a plurality of lenses. In detail, at least two lenses in the first lens group G1 may have opposite refractive powers. For example, the first lens group G1 may include three lenses. The plurality of lenses included in the first lens group G1 may have a set interval. In detail, the center interval between the plurality of lenses included in the first lens group G1 may be a fixed interval according to an operation mode to be described later. For example, the center interval between the first lens 110 and the second lens 120 and the center interval between the second lens 120 and the third lens 130 do not change depending on the operation mode and may have regular intervals. Here, the center interval between the plurality of lenses may mean a distance between adjacent lenses on the optical axis.

The second lens group G2 may include at least one lens. The second lens group G2 may include a plurality of lenses. In detail, the second lens group G2 may include two or more lenses having opposite refractive powers. The number of lenses included in the second lens group G2 may be less than the number of lenses included in the first lens group G1 by one or more. For example, the second lens group G2 may include two lenses. The plurality of lenses included in the second lens group G2 may have a set interval. In detail, the center interval between the plurality of lenses included in the second lens group G2 may be a fixed interval according to an operation mode to be described later. For example, a center interval between the fourth lens 140 and the fifth lens 150 may have a constant interval without changing according to an operation mode.

The third lens group G3 may include at least one lens. The third lens group G3 may include a plurality of lenses. In detail, the third lens group G3 may include two or more lenses having opposite refractive powers. The number of lenses included in the third lens group G3 may be less than the number of lenses included in the first lens group G1 by one or more. The number of lenses included in the third lens group G3 may be the same as the number of lenses included in the second lens group G2. For example, the third lens group G3 may include two lenses. The plurality of lenses included in the third lens group G3 may have a set interval. In detail, the center interval between the plurality of lenses included in the third lens group G3 may be constant without changing even when an operation mode, which will be described later, changes. For example, the center interval between the sixth lens 160 and the seventh lens 170 may be constant without changing according to an operation mode.

The fourth lens group G4 may include at least one lens. The number of lenses included in the fourth lens group G4 may be less than the number of lenses included in the first lens group G1. The number of lenses included in the fourth lens group G4 may be less than or equal to the number of lenses included in the second lens group G2 and the third lens group G3. For example, the fourth lens group G4 may include one lens. The lenses included in the fourth lens group G4 may have a set distance from the image sensor 220 and/or the optical filter 220. In detail, the optical axis interval between the lens included in the fourth lens group G4 and the image sensor 200 may be constant without changing in an operation mode to be described later. As another example, when the fourth lens group G4 includes a plurality of lenses, an optical axis interval between the plurality of lenses may be constant without changing even when an operation mode is changed.

The optical system 1000 may include a plurality of lenses 100 included in the lens groups G1, G2, G3, and G4, for example, first to eighth lenses 110, 120, 130, 140, 150, 160, 170, and 180. The first lens group G1 may include the first to third lenses 110, 120, and 130, and the second lens group G2 may include the fourth and fifth lenses 140 and 150. Also, the third lens group G3 may include the sixth and seventh lenses 160 and 170, and the fourth lens group G4 may include the eighth lens 180. The first to eighth lenses 110, 120, 130, 140, 150, 160, 170, and 180 and the image sensor 200 may be sequentially disposed along the optical axis OA of the optical system 1000.

Each of the plurality of lenses 100 may include an effective region and an ineffective region. The effective region may be a region of an effective diameter, and may be a region through which light incident on each of the first to eighth lenses 110, 120, 130, 140, 150, 160, 170 and 180 passes. The effective region may be a region in which incident light is refracted to implement optical properties. The ineffective region may be disposed around the effective region. The ineffective region may be a region to which the light is not incident. That is, the ineffective region may be a region independent of the optical characteristic. Also, the ineffective region may be a region fixed to a barrel (not shown) for accommodating the lens.

The image sensor 200 may detect light. The image sensor 200 may detect light sequentially passing through the plurality of lenses 100, for example, the first to eighth lenses 110, 120, 130, 140, 150, 160, 170, and 180. The image sensor 200 may include a charge coupled device (CCD) or a complementary metal oxide semiconductor (CMOS).

The optical system 1000 may further include an optical filter 220. The optical filter 220 may be disposed between the plurality of lenses 100 and the image sensor 200. The optical filter 220 may be disposed between the image sensor 200 and the fourth lens group G4. For example, the optical filter 220 may be disposed between the eighth lens 180 of the fourth lens group G4 and the image sensor 200.

The optical filter 220 may include at least one of an infrared filter and a cover glass. The optical filter 220 may pass light of a set wavelength band and filter light of a different wavelength band. When the optical filter 220 includes an infrared filter, radiant heat emitted from external light may be blocked from being transmitted to the image sensor 200. The optical filter 220 may transmit visible light and reflect infrared light.

The optical system 1000 may include an aperture stop (not shown). The aperture stop may control the amount of light incident on the optical system 1000. The aperture stop may be positioned around the object-side surface of the first lens 110 or disposed between two lenses selected from among the first to eighth lenses 110, 120, 130, 140, 150, 160, 170, and 180. For example, the aperture stop may be disposed on a circumference between the third lens 130 and the fourth lens 140. The aperture stop may be disposed around the sensor-side surface of the third lens 130 or the object-side surface of the fourth lens 140. Alternatively, at least one of the first to eighth lenses 110, 120, 130, 140, 150, 160, 170 and 180 may function as an aperture stop. For example, the outer portion of the object-side surface or the sensor-side surface of one lens selected from among the first to eighth lenses 110, 120, 130, 140, 150, 160, 170, and 180 may serve as an aperture stop for controlling the amount of light. For example, at least one of the sensor-side surface of the third lens 130 and the object-side surface of the fourth lens 140 may serve as an aperture stop.

The object-side surface and the sensor-side surface of the first to eighth lenses 110, 120, 130, 140, 150, 160, 170 and 180 may be aspherical. The third and fourth lenses 130 and 140 may be aspherical lenses, or plastic or glass molded materials. The first, second, fifth, sixth, seventh, and eighth lenses 110, 120, 150, 160, 170 and 180 may be formed of a plastic material or an aspherical lens.

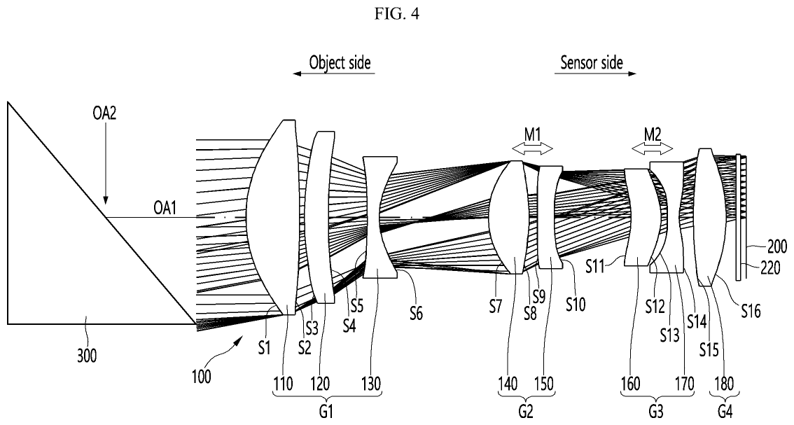

The optical system 1000 may further include a light path changing member 300 as shown in FIG. 4. The light path changing member 300 may change the path of the light from the second path OA2 to the first path OA1 by reflecting the light incident from the outside. The light path changing member 300 may include a reflective mirror or a prism. For example, the light path changing member 300 may include a right-angled prism. When the light path changing member 300 includes a right-angle prism, the light path changing member 300 reflects the second path OA2 of the incident light to an angle of 90 degrees to change the first path OA1 of the light. The first path OA1 may be in the optical axis direction of the optical system. The light path changing member 300 may be disposed closer to the object side than the plurality of lenses 100. That is, when the optical system 1000 includes the light path changing member 300, the light path changing member 300, the first lens 110, the second lens 120, the third lens 130, fourth lens 140, fifth lens 150, sixth lens 160, seventh lens 170, eighth lens 180, filter 220, and image sensor 200 may be arranged in order from the object side toward the sensor direction.

The light path changing member 300 may change the path of the externally incident light in a set direction. For example, the light path changing member 300 may change the second path OA2 of the light incident to the light path changing member 300 in a first direction to the first path OA1 of a second direction, which is the arrangement direction of the plurality of lenses 100. When the optical system 1000 includes the light path changing member 300, the optical system may be applied to a folded camera, thereby reducing the thickness of the camera. In detail, when the optical system 1000 includes the light path changing member 300, the light incident in a direction (a first direction) perpendicular to the surface of the device to which the optical system 1000 is applied may be changed in a parallel direction (a second direction) to the surface of the device. Accordingly, the optical system 1000 including the plurality of lenses 100 may have a thinner thickness in the device, and thus the height of the device may be reduced.

For example, when the optical system 1000 does not include the light path changing member, the plurality of lenses 100 in the device may be disposed to extend in a direction (first direction) perpendicular to the surface of the device. Accordingly, the optical system 1000 including the plurality of lenses 100 has a high height in a direction (first direction) perpendicular to the surface of the device, and thereby the optical system 1000 and a device including the same may be difficult to form a thin thickness. However, when the optical system 1000 includes the light path changing member 300, the plurality of lenses 100 may be disposed to extend in a parallel direction (a second direction) to the surface of the device. That is, the optical system 1000 is disposed so that the optical axis OA is parallel to the surface of the device and may be applied to a folded camera. Accordingly, the optical system 1000 including the plurality of lenses 100 may have a low height in a direction perpendicular to the surface of the device. Accordingly, the camera including the optical system 1000 may have a thin thickness in the device, and the thickness of the device may also be reduced.

As another example, the light path changing member may be disposed between two of the plurality of lenses 100, or between the last lens adjacent to the image sensor 200 and the image sensor 200. As another example, a plurality of light path changing members may be provided. In detail, a plurality of light path changing members may be disposed between the object and the image sensor 200. For example, the plurality of light path changing members may include a first light path changing member disposed closer to the object side than the plurality of lenses 100 and a second light path changing member disposed between the last lens and the image sensor 200. Accordingly, the optical system 1000 may have various shapes and heights depending on an applied camera, and may have improved optical performance.

Referring to FIGS. 1 to 3, referring to the plurality of lenses 100 again, the optical system 1000 may include first to eighth lenses 110, 120, 130, 140, 150, 160, 170 and 180 sequentially arranged along the optical axis OA from the object side to the sensor direction. The first lens 110 may be disposed closest to the object side among the plurality of lenses 100, and the eighth lens 180 may be disposed closest to a side of the image sensor 200.

The first lens 110 may have a positive (+) refractive power on the optical axis OA. The first lens 110 may include a plastic or glass material, for example, a plastic material. The first lens 110 may include a first surface S1 defined as an object-ide surface and a second surface S2 defined as a sensor-side surface. The first surface S1 may have a convex shape on the optical axis OA, and the second surface S2 may have a convex shape on the optical axis OA. That is, the first lens 110 may have a shape convex to both sides on the optical axis OA. Alternatively, the second surface S2 of the first lens 110 may have a concave shape on the optical axis OA, and may have a meniscus shape convex toward the object side. At least one of the first surface S1 and the second surface S2 may be an aspherical surface. For example, both the first surface S1 and the second surface S2 may be aspherical.

The center thickness L1CT of the first lens 110 is a thickness on the optical axis, and may be thicker than twice the edge thickness L1ET. The edge thickness L1ET is a distance in a direction of the optical axis between an edge of the object-side surface and an edge of the sensor-side surface of the first lens 110. Accordingly, the first lens 110 may improve optical aberration or control the incident light. The end of the first surface S1 of the first lens 180 may be located on the sensor side rather than a straight line orthogonal to the center of the first surface S1, and the end of the second surface S2 may be located on the object side rather than a straight line orthogonal to the center of the second surface S2. Here, the ends of the first and second surfaces S1 and S2 may be the ends of the effective diameter or the outer circumference. The first surface S1 and the second surface S2 may be provided without an inflection point from the optical axis to the end of the effective region.

The second lens 120 may have positive (+) or negative (−) refractive power on the optical axis OA. The second lens 120 may include a plastic or glass material, for example, a plastic material. The second lens 120 may include a third surface S3 defined as an object-ide surface and a fourth surface S4 defined as a sensor-side surface. The third surface S3 may have a convex shape on the optical axis OA, and the fourth surface S4 may have a concave shape on the optical axis OA. The second lens 120 may have a meniscus shape convex from the optical axis OA toward the object side. Alternatively, the third surface S3 may have a convex shape on the optical axis OA, and the fourth surface S4 may have a convex shape. That is, the second lens 120 may have a shape in which both sides are convex on the optical axis OA. Alternatively, the third surface S3 may have a concave shape on the optical axis OA, and the fourth surface S4 may have a convex shape on the optical axis OA. That is, the second lens 120 may have a meniscus shape convex from the optical axis OA toward the sensor side. Alternatively, the third surface S3 may have a concave shape on the optical axis OA, and the fourth surface S4 may have a concave shape on the optical axis OA. That is, the second lens 120 may have a concave shape on both sides of the optical axis OA. At least one of the third surface S3 and the fourth surface S4 may be an aspherical surface. For example, both the third surface S3 and the fourth surface S4 may be aspherical. The third surface S3 and the fourth surface S4 may be provided without an inflection point from the optical axis to the end of the effective region.

The third lens 130 may have a refractive power opposite to that of the first lens 110 on the optical axis OA. That is, the third lens 130 may have negative (−) refractive power. The third lens 130 may include a plastic or glass mode material, for example, a glass mold material, and may have a refractive index of 1.75 or more. The third lens 130 may include a fifth surface S5 defined as an object-ide surface and a sixth surface S6 defined as a sensor-side surface. The fifth surface S5 may have a concave shape on the optical axis OA, and the sixth surface S6 may have a concave shape on the optical axis OA. That is, the third lens 130 may have a shape in which both sides are concave on the optical axis OA. Alternatively, the fifth surface S5 may have a convex shape on the optical axis OA, and the sixth surface S6 may have a concave shape on the optical axis OA. That is, the third lens 130 may have a meniscus shape convex from the optical axis OA toward the object side. At least one of the fifth surface S5 and the sixth surface S6 may be an aspherical surface. For example, both the fifth surface S5 and the sixth surface S6 may be aspherical. The fifth surface S5 and the sixth surface S6 may be provided without an inflection point from the optical axis to the end of the effective region.

The object-side first lens 110 of the first lens group G1 may have a refractive power opposite to that of the sensor-side third lens 130. Accordingly, the plurality of lenses 110, 120, and 130 included in the first lens group G1 may mutually compensate for chromatic aberration. In the first lens group G1, the third lens 130 adjacent to the second lens group G2 may have the largest refractive index in the first lens group G1. For example, the refractive index of the third lens 130 may be greater than 1.6 or greater than or equal to 1.75. Accordingly, since the first lens group G1 controls the light provided to the second lens group G2, the lens size of the second lens group G2 may be reduced.

The fourth lens 140 may have a positive (+) refractive power on the optical axis OA. The fourth lens 140 may include a plastic or glass material, for example, a glass mode material, and may have a refractive index of 1.6 or less. The fourth lens 140 may include a seventh surface S7 defined as an object-ide surface and an eighth surface S8 defined as a sensor-side surface. The seventh surface S7 may have a convex shape on the optical axis OA, and the eighth surface S8 may have a convex shape on the optical axis OA. That is, the fourth lens 140 may have a convex shape on both sides of the optical axis OA. Alternatively, the seventh surface S7 may be convex shape on the optical axis OA, and the eighth surface S8 may be concave shape on the optical axis OA. That is, the fourth lens 140 may have a meniscus shape convex from the optical axis OA toward the object side. At least one of the seventh surface S7 and the eighth surface S8 may be an aspherical surface. For example, both the seventh surface S7 and the eighth surface S8 may be aspherical. The seventh surface S7 and the eighth surface S8 may be provided without an inflection point from the optical axis to the end of the effective region.

The fifth lens 150 may have positive (+) or negative (−) refractive power on the optical axis OA. The fifth lens 150 may have a refractive power opposite to that of the fourth lens 140 on the optical axis OA. The fifth lens 150 may include a plastic or glass material, for example, a plastic material. The fifth lens 150 may include a ninth surface S9 defined as an object-ide surface and a tenth surface S10 defined as a sensor-side surface. The ninth surface S9 may have a concave shape on the optical axis OA, and the tenth surface S10 may have a concave shape on the optical axis OA. That is, the fifth lens 150 may have a concave shape on both sides of the optical axis OA. At least one of the ninth surface S9 and the tenth surface S10 may be an aspherical surface. For example, both the ninth surface S9 and the tenth surface S10 may be aspherical.

The ninth surface S9 of the fifth lens 150 may have at least one inflection point, and the inflection point may be disposed closer to the optical axis than the end of the ninth surface S9. A position of the inflection point of the ninth surface S9 may be arranged in a range of 30% or less, for example, 10% to 30% of an effective radius of the ninth surface S9 with respect to the optical axis. The effective radius is a distance from the optical axis of each lens surface to the end of the effective region. The inflection point is a point at which the sign of the inclination value with respect to the optical axis OA and the direction perpendicular to the optical axis OA changes from positive (+) to negative (−) or from negative (−) to positive (+), and may mean a point where the inclination value is 0. Also, the inflection point may be a point at which the inclination value of the tangent line passing through the lens surface becomes smaller as it increases, or a point at which it becomes smaller and then increases.

As another example, the ninth surface S9 of the fifth lens 150 may have a convex shape on the optical axis OA, and the tenth surface S10 may have a convex shape on the optical axis OA. That is, the fifth lens 150 may have a shape in which both sides are convex on the optical axis OA. Alternatively, the ninth surface S9 may have a concave shape on the optical axis OA, and the tenth surface S10 may have a convex shape on the optical axis OA. That is, the fifth lens 150 may have a meniscus shape convex from the optical axis OA toward the sensor side. Alternatively, the ninth surface S9 may have a convex shape on the optical axis OA, and the tenth surface S10 may have a concave shape on the optical axis OA.

The object-side fourth lens 140 of the second lens group G2 may have a refractive power opposite to that of the sensor-side fifth lens 150. The difference between the Abbe number between the fourth lens 140 and the fifth lens 150 may be greater than 20 or greater than 30, and may be up to 60 or less. Accordingly, the second lens group G2 may minimize a change in chromatic aberration caused by a position that changes according to a change in the operation mode.

The sixth lens 160 may have positive (+) or negative (−) refractive power on the optical axis OA. The sixth lens 160 may include a plastic or glass material, for example, a plastic material. The sixth lens 160 may include an eleventh surface S11 defined as an object-ide surface and a twelfth surface S12 defined as a sensor-side surface. The eleventh surface S11 may have a concave shape on the optical axis OA, and the twelfth surface S12 may have a convex shape on the optical axis OA. That is, the sixth lens 160 may have a meniscus shape convex from the optical axis OA toward the sensor side. Alternatively, the eleventh surface S11 may have a convex shape on the optical axis OA, and the twelfth surface S12 may have a convex shape on the optical axis OA. That is, the sixth lens 160 may have a shape in which both sides are convex on the optical axis OA. Alternatively, the eleventh surface S11 may have a concave shape on the optical axis OA, and the twelfth surface S12 may have a concave shape on the optical axis OA. That is, the sixth lens 160 may have a concave shape on both sides of the optical axis OA. Alternatively, the eleventh surface S11 may have a convex shape on the optical axis OA, and the twelfth surface S12 may have a concave shape on the optical axis OA. That is, the sixth lens 160 may have a meniscus shape convex from the optical axis OA toward the object side.

At least one of the eleventh surface S11 and the twelfth surface S12 of the sixth lens 160 may be an aspherical surface. For example, both the eleventh surface S11 and the twelfth surface S12 may be aspherical. The eleventh surface S11 and the twelfth surface S12 may be provided without an inflection point from the optical axis to the end of the effective region.

The seventh lens 170 may have positive (+) or negative (−) refractive power on the optical axis OA. The seventh lens 170 may have a refractive power opposite to that of the sixth lens 160 on the optical axis OA. The seventh lens 170 may include a plastic or glass material, for example, a plastic material.

The seventh lens 170 may include a thirteenth surface S13 defined as an object-ide surface and a fourteenth surface S14 defined as a sensor-side surface. The thirteenth surface S13 may have a convex shape on the optical axis OA, and the fourteenth surface S14 may have a concave shape on the optical axis OA. That is, the seventh lens 170 may have a meniscus shape convex from the optical axis OA toward the object side. As another example, the thirteenth surface S13 may have a convex shape on the optical axis OA, and the fourteenth surface S14 may have a convex shape on the optical axis OA. That is, the seventh lens 170 may have a shape in which both sides are convex on the optical axis OA. Alternatively, the thirteenth surface S13 may have a concave shape on the optical axis OA, and the fourteenth surface S14 may have a convex shape on the optical axis OA. That is, the seventh lens 170 may have a meniscus shape convex from the optical axis OA toward the sensor side. Alternatively, the thirteenth surface S13 may have a concave shape on the optical axis OA, and the fourteenth surface S14 may have a concave shape on the optical axis OA. That is, the seventh lens 170 may have a concave shape on both sides of the optical axis OA.

The thirteenth surface S13 of the seventh lens 170 may have at least one inflection point, and the inflection point may be disposed closer to the optical axis than the end of the thirteenth surface S13. A position of the inflection point of the thirteenth surface S13 may be 30% or less of the effective radius of the thirteenth surface S13 with respect to the optical axis, for example, in a range of 10% to 30%. The thirteenth surface S13 may refract the light incident by the inflection point in the optical axis direction and the edge direction.

The fourteenth surface S14 of the seventh lens 170 may have at least one inflection point, and the inflection point may be disposed closer to an end than the optical axis of the fourteenth surface S14. A position of the inflection point of the fourteenth surface S14 may be arranged in a range of 85% or more, for example, 85% to 95% of an effective radius of the fourteenth surface S14 with respect to the optical axis. Since the inflection point of the fourteenth surface S14 is disposed adjacent to the edge, light may be refracted toward the edge of the eighth lens 180. The effective diameter of the seventh lens 170 may be reduced by the inflection points of the thirteenth and fourteenth surfaces S13 and S14. At least one of the thirteenth surface S13 and the fourteenth surface S14 may be an aspherical surface. For example, both the thirteenth surface S13 and the fourteenth surface S14 may be aspherical.

The object-side sixth lens 160 of the third lens group G3 may have a refractive power opposite to that of the sensor-side seventh lens 170. The Abbe number difference between the sixth lens 160 and the seventh lens 170 may be 20 or more, for example, in the range of 20 to 45. Accordingly, the third lens group G3 may perform an achromatic function while minimizing a change in chromatic aberration caused by a position that changes according to a mode change.

The eighth lens 180 may have positive (+) refractive power on the optical axis OA. The eighth lens 180 may include a plastic or glass material, for example, a plastic material. The eighth lens 180 may include a fifteenth surface S15 defined as an object-side surface and a sixteenth surface S16 defined as a sensor-side surface. The fifteenth surface S15 may have a convex shape on the optical axis OA, and the sixteenth surface S16 may have a convex shape on the optical axis OA. That is, the eighth lens 180 may have a shape in which both sides are convex on the optical axis OA. Alternatively, the eighth lens 180 may have a concave shape on the optical axis OA, and the sixteenth surface S16 may have a convex shape on the optical axis OA. That is, the eighth lens 180 may have a meniscus shape convex from the optical axis OA toward the sensor side. At least one of the fifteenth surface S15 and the sixteenth surface S16 may be an aspherical surface. For example, both the fifteenth surface S15 and the sixteenth surface S16 may be aspherical. The eighth lens 180 may have a shape in which the object-side fifteenth surface S15 and the sensor-side sixteenth surface S16 have no inflection points.

The center thickness L8CT of the eighth lens 180 may be 1.5 times or more thicker than the edge thickness L8ET. Accordingly, distortion may be reduced due to the difference between the center thickness and the edge thickness of the eighth lens 180. The end of the fifteenth surface S15 of the eighth lens 180 may be located on the sensor side based on a straight line orthogonal to the center of the fifteenth surface S15, and the end of the sixteenth surface S16 may be located on the object side with respect to a straight line perpendicular to the center of the sixteenth surface S16. One or both of the fifteenth surface S15 and the sixteenth surface S16 of the eighth lens 180 may be provided as an aspherical surface having no inflection point.

The fourth lens group G4 may be closest to the image sensor 200 among the plurality of lens groups G1, G2, G3, and G4. In particular, the eighth lens 180 closest to the image sensor 200 may have the shortest path of light among the plurality of lenses 100. The fourth lens group G4 may serve to control a chief ray angle (CRA). In detail, the CRA of the optical system 1000 according to the embodiment may be less than about 10 degrees, and the eighth lens 180 of the fourth lens group G4 may be corrected such that a chief ray angle (CRA) of light incident on the image sensor 200 is close to 0 degrees.

At least one of the plurality of lenses 100 may have a non-circular shape. The lens of the non-circular shape may be one or two lenses that are close to the object side and have a large effective radius, and may not be spherical at one or both ends orthogonal to the optical axis. The optical system 1000 according to the embodiment may have an improved assembling property and a mechanically stable shape. In addition, the optical system 1000 may significantly reduce the moving distance of the moving lens group and provide various magnifications.

A camera module (not shown) according to an embodiment of the invention may include the above-described optical system 1000. The camera module may move at least one lens group among the plurality of lens groups G1, G2, G3 and G4 included in the optical system 1000 in a direction of the optical axis OA. The camera module may include a driving member (not shown) connected to the optical system 1000. The driving member may move at least one lens group in the direction of the optical axis OA according to an operation mode. The operation mode may include a first mode operating at a first magnification and a second mode operating at a second magnification different from the first magnification. In this case, the second magnification may be greater than the first magnification. Also, the operation mode may include a third mode that operates at a third magnification that is between the first and second magnifications. Here, the first magnification may be the lowest magnification of the optical system 1000, and the second magnification may be the highest magnification of the optical system 1000. The first magnification may be about 3 to about 5 magnifications, the second magnification may be about 8 to 11 magnifications, and the third magnification may be from about 5 to 8 magnifications between the first and second magnifications.

The driving member may move at least one lens group according to one operation mode selected from among the first to third modes or may operate in an initial mode. In detail, the driving member is connected to the second lens group G2 and the third lens group G3, and may move the second lens group G2 and the third lens group G3 according to an operation mode. The initial mode may be any one of the first, second, and third modes, for example, the first mode. For example, in the first mode, each of the second lens group G2 and the third lens group G3 may be located at a position defined by the first position (Position 1). In the second mode, each of the second lens group G2 and the third lens group G3 may be located at a position defined by a second position (Position 2) different from the first position. In the third mode, each of the second lens group G2 and the third lens group G3 may be located at a position defined by a third position (Position 3) different from the first and second positions. The third position may be a region between the first and second positions. For example, the third positions at which the second lens group G2 is located in the third mode may be a region between the first and second positions at which the second lens group G2 is located in the first and second modes. In addition, a third position at which the third lens group G3 is located in the third mode may be a region between the first and second positions at which the third lens group G3 is located in the first and second modes.

In the optical system 1000 according to the embodiment, the second lens group G2 and the third lens group G3 may move according to an operation mode, and the first lens group G1 and the fourth lens group G4 may be disposed in a fixed position. According to the operation mode, the second lens group G2 or the third lens group G3 may be moved, and the first lens group G1 and the fourth lens group G4 may be disposed at fixed positions. In each of the first position, the second position, and the third position according to the operation mode, the first to fourth lens groups G1, G2, G3, and G4 may have a set distance from an adjacent lens group. Accordingly, the optical system 1000 may have a constant total track length (TTL) even when the operation mode is changed, and the effective focal length and magnification of the optical system 1000 may be controlled by controlling the positions of some lens groups.

The effective diameter of the first lens 110 is the largest among the effective diameters of the lenses, the effective diameter of the fourth lens 140 may be the second largest among the effective diameters of the lenses, and the effective diameter of the eighth lens 180 may be the third largest among the effective diameters of the lenses. The effective diameter of the third lens 130 and/or the seventh lens 170 may be the smallest among the effective diameters of the lenses. The refractive index of the third lens 130 may be the largest among the refractive indices of the lenses, and may be 1.75 or more. The Abbe number of the fourth lens 140 may be the largest among Abbe numbers of the lenses, and may be 60 or more. In the absolute value of the focal length, the focal length of the second lens 120 may be the largest among the focal lengths of the lenses.

The optical system 1000 according to the embodiment may satisfy at least one or two or more of the following equations. Accordingly, the optical system 1000 according to the embodiment may effectively correct aberrations that change according to a change in the operation mode. In addition, the optical system 1000 according to the embodiment may effectively provide an autofocus (AF) function for a subject at various magnifications, and may have a slim and compact structure.

$$n\_G1 , n\_G2 , n\_G3 > \qquad [ Equation 1 ]$$

$$1 ( n\_G1 , n\_G2 , n\_G3 are natural numbers )$$

In Equation 1, n_G1, n_G2, and n_G3 mean the number of lenses included in each of the first to third lens groups G1, G2, and G3. Here, it may have a relationship of n_G1>n_G2 and n_G1>n_G3.

$$CA\_L4S7 / CA\_L1S1 < 0.7 \qquad [ Equation 2 ]$$

In Equation 2, CA_L4S7 is an effective diameter of the seventh surface S7 of the fourth lens 140, and CA_L1S1 is an effective diameter of the first surface S1 of the first lens 110. When Equation 2 is satisfied, it is possible to provide a higher entrance pupil diameter (EPD) compared to the optical system.

$$2 < L 1 CT / L 3 CT < 5 \qquad [ Equation 3 ]$$

In Equation 3, L1CT is a thickness (mm) on the optical axis of the first lens 110, and L3CT is a thickness (mm) on the optical axis of the third lens 130. When Equation 3 is satisfied, aberration specification in the optical system 1000 may be improved.

$$1 < L 8 ET / L 8 CT < 4 \qquad [ Equation 4 ]$$

In Equation 4, L8CT means a thickness (mm) on the optical axis OA of the eighth lens 180, and L8_ET means a thickness (mm) on the optical axis OA direction at the end of the effective region of the eighth lens 180. In detail, the L8ET means a distance between an end of the effective region of the object-side surface (fifteenth surface S15) of the eighth lens 180 and an end of the effective region of the sensor-side surface (sixteenth surface S16) in a direction of the optical axis OA. When the optical system 1000 according to the embodiment satisfies Equation 4, the optical system 1000 may reduce distortion and thus have improved optical performance.

$$EFL\_G1 < 0 \qquad [ Equation 5 ]$$

In Equation 5, EFL_G1 is the effective focal length EFL of the first lens group G1, and may have a value less than 0. When Equation 5 is satisfied, the optical aberration of the optical system or the optical aberration of the first lens group G1 may be improved.

$$\\ \begin{matrix}CRA < 10 & [ Equation 6 ]\end{matrix}$$

In Equation 6, CRA (Chief Ray Angle) is an incident angle of the chief ray, and the incident angle of the chief ray may be less than 10 degrees, for example, 6 degrees or less according to the first, second, and third modes in the optical system. The first mode may be a wide mode, the second mode may be a tele mode, and the third mode may be a middle mode. Here, in the case of the first mode (Wide), the incident angle of the chief ray may be greater than the incident angle of the chief ray in the case of the third mode (Middle) in one field. In the case of the first and second modes (Wide and Tele), the incident angle of the chief ray in one field may be in the range of 4 degrees to 6 degrees, and the incident angle of the chief ray in the second mode may be greater than the incident angle of the chief ray in the first mode. When Equation 6 is satisfied, the ambient light quantity ratio may be secured.

$$\\ \begin{matrix}Min\_Relative illumination > 40 & [ Equation 7 ]\end{matrix}$$

In Equation 7, Min_Relative illumination is the minimum relative illuminance (unit %) value according to the first to third modes, and when Equation 7 is satisfied, the ambient light intensity ratio of the optical system may be secured.

$$\\ \begin{matrix}( TTL / L\_G 1 ) > 3.5 & [ Equation 8 ]\end{matrix}$$

In Equation 8, L_G1 means a distance on the optical axis OA between the object-side surface of the lens closest to the object and the sensor-side surface of the lens closest to the image sensor 200 among the lenses included in the first lens group G1. For example, L_G1 means a distance (mm) between the first surface S1 of the first lens 110 and the sixth surface S6 of the third lens 130 on the optical axis OA. Total track length (TTL) means a distance (mm) on the optical axis OA from the object-side surface (first surface S1) of the first lens 110 to the upper surface of the image sensor 200. When the optical system 1000 according to the embodiment satisfies Equation 8, the optical system 1000 has a relatively small TTL, and the ambient light ratio may be secured.

$$\\ \begin{matrix}TTL / EPD\_Tele < 2.72 & [ Equation 9 ]\end{matrix}$$

In Equation 9, EPD_Tele means the entrance pupil diameter (EPD) of the optical system 1000 when operating in the second mode, that is, the Tele mode. When the optical system 1000 according to the embodiment satisfies Equation 9, the optical system 1000 may secure a bright image during the second mode operation and may be the minimum condition for securing F number of 4 or less.

$$\\ \begin{matrix}2 < L\_Max \_CT / L\_Min \_CT < 6 & [ Equation 10 ]\end{matrix}$$

In Equation 10, L_Max_CT is the thickest thickness on the optical axis OA among the lenses, and L_Min_CT is the thinnest thickness on the optical axis OA among the lenses, and may improve optical aberration characteristics.

$$\\ \begin{matrix}1 < L\_Max \_CA / L\_Min \_CA < 3 & [ Equation 11 ]\end{matrix}$$

In Equation 11, L_Max_CA is the largest effective diameter among the effective diameters of the lenses, and L_Min_CA is the smallest effective diameter among the effective diameters of the lenses.

$$\\ \begin{matrix}CA\_G 1 min / CA\_G 4 max < CA\_G 1 max & [ Equation 12 ]\end{matrix}$$

In Equation 12, CA_G1max is the largest effective diameter among the effective diameters of the object-side and sensor-side surfaces of the lenses included in the first lens group G1, and CA_G1min is the smallest effective diameter among the effective diameters of the object-side and sensor-side surfaces of the lenses included in the first lens group G1, and CA_G4max is the largest effective diameter among the effective diameters of the object-side surface or the sensor-side surface of the lens of the fourth lens group G4. When Equation 12 is satisfied, the optical performance of the optical system may be maintained.

When the optical system 1000 according to the embodiment satisfies at least one or two or more of Equations 1 to 12, the optical system 1000 may have a slim structure. In addition, the optical system 1000 may have an improved assembling property and a mechanically stable shape.

$$\\ \begin{matrix}1 < L\_G 1 / L\_G 2 < 3 & [ Equation 13 ]\end{matrix}$$

In Equation 13, L_G1 is the distance on the optical axis OA between the object-side surface of the lens closest to the object and the sensor-side surface of the lens closest to the image sensor 200 among the lenses included in the first lens group G1. For example, L_G1 means a distance between the first surface S1 of the first lens 110 and the sixth surface S6 of the third lens 130 on the optical axis OA. L_G2 means the distance on the optical axis OA between the object-side surface of the lens closest to the object and the sensor-side surface of the lens closest to the image sensor 200 among the lenses included in the second lens group G2. For example, L_G2 means a distance between the seventh surface S7 of the fourth lens 140 and the tenth surface S10 of the fifth lens 150 on the optical axis OA.

$$\\ \begin{matrix}1 < L\_G 1 / L\_G 3 < 4 & [ Equation 14 ]\end{matrix}$$

In Equation 14, L_G1 is the distance on the optical axis OA between the object-side surface of the lens closest to the object and the sensor-side surface of the lens closest to the image sensor 200 among the lenses included in the first lens group G1. For example, L_G1 means a distance between the first surface S1 of the first lens 110 and the sixth surface S6 of the third lens 130 on the optical axis OA. L_G3 means a distance on the optical axis OA between the object-side surface of the lens closest to the object and the sensor-side surface of the lens closest to the image sensor 200 among the lenses included in the third lens group G3. For example, L_G3 means a distance between the eleventh surface S11 of the sixth lens 160 and the fourteenth surface S14 of the seventh lens 170 on the optical axis OA. When the optical system 1000 according to the embodiment satisfies at least one of Equations 13 and 14, it has a relatively small TTL and may provide various magnifications according to at least three mode changes.

$$\\ \begin{matrix}0.02 < d 23 / TTL < 0.5 & [ Equation 15 ]\end{matrix}$$

In Equation 15, d23 is a distance on the optical axis between the second lens 120 and the third lens 130. When the optical system 1000 satisfies Equation 15, the optical system 1000 has a relatively small TTL, and may have improved optical properties by controlling stray light incident on the first lens group G1.

$$\\ \begin{matrix}5 < TTL / L\_G 2 < 12 & [ Equation 16 ]\end{matrix}$$

In Equation 16, L_G2 means the distance on the optical axis OA between the object-side surface of the lens closest to the object and the sensor-side surface of the lens closest to the image sensor 200 among the lenses included in the second lens group G2. For example, L_G2 means a distance between the seventh surface S7 of the fourth lens 140 and the tenth surface S10 of the fifth lens 150 on the optical axis OA. When the optical system 1000 according to the embodiment satisfies Equation 16, the optical system 1000 has a relatively small TTL, and chromatic aberration characteristics may be improved.

$$\\ \begin{matrix}20 < \vert vd 4 - vd 5 \vert & [ Equation 17 ]\end{matrix}$$

In Equation 17, vd4 means an Abbe number of the fourth lens 140, and vd5 means an Abbe number of the fifth lens 150. When the absolute value of the Abbe number difference between the fourth and fifth lenses of the optical system 1000 according to the embodiment satisfies Equation 17, the optical system 1000 may improve chromatic aberration characteristics.

$$\\ \begin{matrix}20 < \vert vd 6 - vd 7 \vert & [ Equation 18 ]\end{matrix}$$

In Equation 18, vd6 means an Abbe number of the sixth lens, and vd7 means an Abbe number of the seventh lens. When the absolute value of Abbe number difference between the sixth and seventh lenses satisfies Equation 18, the optical system 1000 may improve chromatic aberration characteristics.

$$\\ \begin{matrix}1.6 < n 3 d & [ Equation 19 ]\end{matrix}$$

In Equation 19, n3d means the refractive index of the third lens 130. When the optical system 1000 according to the embodiment satisfies Equation 19, the effective region of the lens disposed after the third lens 130 may be secured and the height of the lens may be reduced.

$$\\ \begin{matrix}1 < L 1 R 1 / L 3 R 2 < 2.5 & [ Equation 20 ]\end{matrix}$$

In Equation 20, L1R1 means a radius of curvature of the object-side surface (first surface S1) of the first lens 110, and L3R2 means a radius of curvature of the sensor-side surface (sixth surface S6) of the third lens 130. When the optical system 1000 according to the embodiment satisfies Equation 20, the optical system 1000 may control stray light incident on the first lens group G1.

$$1 < L 1 R 1 / L 4 R 1 < 2.5 \qquad [ Equation 21 ]$$

In Equation 21, L1R1 means a radius of curvature of the object-side surface (first surface S1) of the first lens 110, and L4R1 means a radius of curvature of the object-side surface (seventh surface S7) of the fourth lens 140. When the optical system 1000 according to the embodiment satisfies Equation 21, the optical system 1000 may have good optical performance at various magnifications.

$$0 < L 3 R 2 / L 4 R 1 < 2 \qquad [ Equation 22 ]$$

In Equation 22, L3R2 means the radius of curvature of the sensor-side surface (sixth surface S6) of the third lens 130, and L4R1 means the radius of curvature of the object-side surface (seventh surface S7) of the fourth lens 140. When the optical system 1000 according to the embodiment satisfies Equation 22, the optical system 1000 may have good optical performance at the periphery of the field of view (FOV) when operating at various magnifications of at least three modes.

$$- 1.5 < L 1 R 1 / L 8 R 2 < 0 \qquad [ Equation 23 ]$$

In Equation 23, L1R1 means the radius of curvature of the object-side surface (first surface S1) of the first lens 110, and L8R2 means the radius of curvature of the sensor-side surface (sixteenth surface S16) of the eighth lens 180. When the optical system 1000 according to the embodiment satisfies Equation 23, the optical system 1000 may have good optical performance at the center portion and the periphery portion of the FOV.

$$0.05 < m\_G 2 / TTL < 0.5 \qquad [ Equation 24 ]$$

In Equation 24, m_G2 means a moving distance (unit: mm) of the second lens group G2 when changing from the first mode operating at the first magnification to the second mode operating at the second magnification or from the second mode to the first mode. In detail, m_G2 means the value for the difference between an interval on the optical axis OA between the first and second lens groups G1 and G2 in the first mode and an interval on the optical axis OA between the first and second lens groups G1 and G2 in the second mode. When the optical system 1000 according to the embodiment satisfies Equation 24, the optical system 1000 may minimize the moving distance of the second lens group G2 when the magnification is changed, so that the optical system 1000 may have a slim structure. In addition, it is possible to minimize the moving distance when the position of the second lens group G2 is controlled, so that it is possible to have improved power consumption characteristics.

$$0.05 < m\_G3 / TTL < 0.5 \qquad [ Equation 25 ]$$

In Equation 25, m_G3 means a moving distance (unit: mm) of the third lens group G3 when changing from the first mode operating at the second magnification to the second mode operating at the first magnification or from the second mode to the first mode. In detail, m_G3 means the value of the difference between an interval on the optical axis OA between the third and fourth lens groups G3 and G4 in the first mode and an interval on the optical axis OA between the third and fourth lens groups G3 and G4 in the second mode. When the optical system 1000 according to the embodiment satisfies Equation 25, the optical system 1000 may minimize the moving distance of the third lens group G3 when the magnification is changed, so that the optical system 1000 may have a slim structure. In addition, it is possible to minimize the moving distance when the position of the third lens group G3 is controlled, so that it is possible to have improved power consumption characteristics.

$$1.2 < m\_G2 / L\_G2 < 2.5 \qquad [ Equation 26 ]$$

In Equation 26, m_G2 means a moving distance (unit: mm) of the second lens group G2 when changing from the first mode operating at the first magnification to the second mode operating at the second magnification or from the second mode to the first mode. In detail, m_G2 means the value of the difference between an interval on the optical axis OA between the first and second lens groups G1 and G2 in the first mode and an interval on the optical axis OA between the first and second lens groups G1 and G2 in the second mode. L_G2 means a distance on the optical axis OA between the object-side surface of the lens closest to the object and the sensor-side surface of the lens closest to the image sensor 200 among the lenses included in the second lens group G2. For example, L_G2 means a distance between the seventh surface S7 of the fourth lens 140 and the tenth surface S10 of the fifth lens 150 on the optical axis OA. When the optical system 1000 satisfies Equation 26, the optical system 1000 may minimize the moving distance of the second lens group G2 when the magnification is changed, so that the optical system 1000 may have a slim structure. In addition, it is possible to minimize the movement distance when the position of the second lens group G2 is controlled, so that it is possible to have improved power consumption characteristics.

$$2 < m\_G3 / L\_G3 < 3.5 \qquad [ Equation 27 ]$$

In Equation 27, m_G3 means a moving distance (unit: mm) of the third lens group G3 when changing from the first mode operating at the second magnification to the second mode operating at the first magnification or from the second mode to the first mode. In detail, m_G3 means the difference value between an interval on the optical axis OA between the third and fourth lens groups G3 and G4 in the first mode and an interval on the optical axis OA between the third and fourth lens groups G3 and G4 in the second mode. L_G3 means a distance from the optical axis OA of the object-side surface of the lens closest to the object and the sensor-side surface of the lens closest to the image sensor 200 among the lenses included in the third lens group G3. For example, L_G3 means a distance between the eleventh surface S11 of the sixth lens 160 and the fourteenth surface S14 of the seventh lens 170 on the optical axis OA. When the optical system 1000 according to the embodiment satisfies Equation 27, the optical system 1000 may minimize the movement distance of the third lens group G3 when the magnification is changed, so that the optical system 1000 may have a slim structure. In addition, it is possible to minimize the movement distance when the position of the third lens group G3 is controlled, so that it is possible to have improved power consumption characteristics.

$$7 < L1\_CT / ET : L3\_CT / ET < 15 \qquad [ Equation 28 ]$$

In Equation 28, L1_CT/ET is a value obtained by dividing the thickness on the optical axis of the first lens 110 by the thickness at the end of the first lens 110, and L3_CT/ET is a value obtained by dividing the thickness on the optical axis of the third lens 130 as the thickness at the end of the third lens 130. When the value obtained by dividing the center thickness and the end thickness of the first and third lenses 110 and 130 satisfies Equation 28 as the ratio, chromatic aberration may be improved and incident light rays may be controlled.

$$7 < L1\_CT / ET : L7\_CT / ET < 15 \qquad [ Equation 29 ]$$

In Equation 29, L7_CT/ET is a value obtained by dividing the thickness at the optical axis of the seventh lens 170 by the thickness at the end of the seventh lens 170. When the values obtained by dividing the center thickness and the end thickness of the first and seventh lenses 110 and 170 satisfy Equation 29 as the ratio, chromatic aberration may be improved and incident light rays may be controlled. In addition, since the seventh lens 170 has an inflection point and is provided with a thin thickness, distortion characteristics may be improved.

$$4 < dG12\_mode1 / dG34\_mode1 < 12 \qquad [ Equation 30 ]$$

In Equation 30, dG12_mode1 means an interval between the first lens group G1 and the second lens group G2 on the first mode in which the second lens group G2 and the third lens group G3 are disposed at the first position. That is, dG12_mode1 means a distance on the optical axis OA between the third lens 130 and the fourth lens 140 on the first mode.

dG34_mode1 means an interval between the third lens group G3 and the fourth lens group G4 on the first mode in which the second lens group G2 and the third lens group G3 are disposed at the first position. That is, dG34_mode1 means a distance on the optical axis OA between the seventh lens 170 and the eighth lens 180 on the first mode. When the optical system 1000 according to the embodiment satisfies Equation 30, the optical system 1000 may have improved optical properties at the first magnification. In detail, the optical system 1000 may have improved aberration characteristics at the first magnification, and may improve optical performance of the central and peripheral portions of the FOV.

$$0.01 < dG12\_mode2 / dG34\_mode2 < 0.7 \qquad [ Equation 31 ]$$

In Equation 31, dG12_mode2 means an interval between the first lens group G1 and the second lens group G2 on the second mode in which the second lens group G2 and the third lens group G3 are disposed at the second position. That is, dG12_mode2 means a distance on the optical axis OA between the third lens 130 and the fourth lens 140 in the second mode.

dG34_mode2 means an interval between the third lens group G3 and the fourth lens group G4 in the second mode in which the second lens group G2 and the third lens group G3 are disposed at the second positions mean. That is, dG34_mode2 means a distance on the optical axis OA between the seventh lens 170 and the eighth lens 180 on the second mode. When the optical system 1000 according to the embodiment satisfies Equation 31, the optical system 1000 may have improved optical properties at the second magnification. In detail, the optical system 1000 may have improved aberration characteristics at the second magnification and may improve optical performance of the peripheral portion of the FOV.

$$1 < \vert EFL 1 / EFL\_ 2 \vert < 10 \qquad [ Equation 32 ]$$

In Equation 32, EFL_1 is a first effective focal length, and is an effective focal length (EFL) of the optical system in operation of the first mode in which the second lens group G2 and the third lens group G3 are positioned at first position. EFL_2 is a second effective focal length, and an effective focal length (EFL) of the optical system in operation of the second mode in which the second lens group G2 and the third lens group G3 are positioned at the second position.

$$2 < \vert EFL 1 / EPD\_ 1 \vert < 7 \qquad [ Equation 33 ]$$

In Equation 33, EFL_1 is a first effective focal length, and is an effective focal length (EFL) of the optical system in operation of the first mode in which the second lens group G2 and the third lens group G3 are positioned at first position. EPD_1 means an entrance pupil diameter (EPD) of the optical system 1000 in operation of the first mode in which the second lens group G2 and the third lens group G3 are positioned at the first position. When the optical system 1000 according to the embodiment satisfies Equation 33, the optical system 1000 may secure a bright image during the first mode operation.

$$0.1 < EFL\_ 2 / EPD\_ 2 < 3 \qquad [ Equation 34 ]$$

In Equation 34, EFL_2 is a second effective focal length, and is an effective focal length (EFL) of the optical system in operation of the second mode in which the second lens group G2 and the third lens group G3 are positioned at the second position. EPD_2 means an entrance pupil diameter (EPD) of the optical system 1000 during the second mode operation in which the second lens group G2 and the third lens group G3 are positioned at the second position. When the optical system 1000 according to the embodiment satisfies Equation 34, the optical system 1000 may secure a bright image during the second mode operation.

$$F \# \_Mode1 < 3.5 \qquad [ Equation 35 ]$$

$$F \# \_Mode2 < 5$$

In Equation 35, F #_Mode1 means a F-number of the optical system 1000 during the first mode operation in which the second lens group G2 and the third lens group G3 are positioned at first position, and, F #_Mode2 means a F-number of the optical system 1000 during the second mode operation in which the second lens group G2 and the third lens group G3 are positioned at the second position.

$$1 < \vert TTL / EFL\_ 1 \vert < 2 \qquad [ Equation 36 ]$$

In Equation 36, EFL_1 is a first effective focal length, and is an effective focal length (EFL) in the first mode operation in which the second lens group G2 and the third lens group G3 are positioned at first position.

$$0.1 < TTL / EFL\_ 2 < 5 \qquad [ Equation 37 ]$$

In Equation 37, EFL_2 is a second effective focal length, and is effective focal length (EFL) in the second mode operation in which the second lens group G2 and the third lens group G3 are positioned at the second position.

$$1 < L\_Max \_CA / ImgH < 4 \qquad [ Equation 38 ]$$

In Equation 38, L_Max_CA means a size of the largest effective diameter (CA: Clear aperture) among the lens surfaces of the plurality of lenses 100 included in the optical system 1000. ImgH is a distance from 0 field, which is the center of the upper surface of the image sensor 200 overlapping the optical axis OA, to 1.0 field of the image sensor 200, and the distance is a vertical distance from the optical axis OA. That is, ImgH means ½ of the total diagonal length of the effective region of the image sensor 200. When the optical system 1000 according to the embodiment satisfies Equation 38, the optical system 1000 may be provided to be slim and compact. In addition, the optical system 1000 may implement high resolution and high image quality.

$$5 < TTL / ImgH < 10 \qquad [ Equation 39 ]$$

When the optical system 1000 satisfies Equation 39, the optical system 1000 may have a smaller TTL, and thus the optical system 1000 may be provided in a slim and compact structure.

$$15 < TTL / BFL < 30 \qquad [ Equation 40 ]$$

In Equation 40, BFL (back focal length) means a distance on the optical axis OA from the vertex of the sensor-side surface of the lens closest to the image sensor 200 to the upper surface of the image sensor 200.

$$2 < ImgH / BFL < 4 \qquad [ Equation 41 ]$$

When the optical system 1000 according to the embodiment satisfies Equation 39, it is possible to secure the BFL required for a large image sensor of about 1 inch. In addition, when the optical system 1000 satisfies Equation 41, the optical system 1000 may operate at various magnifications while maintaining the TTL, and may have excellent optical characteristics at the center portion and the periphery portion of the FOV.

$$2 < dG 1 G 4 / TTL < 4 \qquad [ Equation 42 ]$$

In Equation 42, dG1G4 is an interval or distance between the sensor-side surface S6 of the first lens group and the object-side surface S15 of the fourth lens group on the optical axis. When Equation 42 is satisfied, it is possible to selectively operate with respect to the first, second, and third magnifications while maintaining the overall TTL, and it is possible to improve optical performance.

$$[ Equation 43 ]$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} +$$

In Equation 43, Z is Sag, which may mean a distance in a direction of the optical axis from an arbitrary position on the aspherical surface to the vertex of the aspherical surface. In addition, Y may mean a distance in a direction perpendicular to the optical axis from any position on the aspherical surface to the optical axis. Also, c may mean a curvature of the lens, and K may mean a conic constant. In addition, A, B, C, D, E, and F may mean an aspheric constant.

The optical system 1000 according to the embodiment may satisfy at least one of Equations 1 to 43 described above. Accordingly, the optical system 1000 and the camera module may have improved optical properties. In detail, as the optical system 1000 satisfies at least one or two or more of Equations 1 to 43, it is possible to effectively correct deterioration of optical properties such as chromatic aberration, vignetting, diffraction effect, and peripheral image quality deterioration caused by movement of the lens group. In addition, the optical system 1000 according to the embodiment may significantly reduce the moving distance of the lens group and provide an autofocus (AF) function for various magnifications with excellent power consumption characteristics.

As the optical system 1000 according to the embodiment satisfies at least one or two or more of Equations 1 to 43, it may have an improved assembling property, may have a mechanically stable shape, and be provided in a slim structure to provide the optical system 1000 and the camera module including the same may have a compact structure.

Hereinafter, the optical system 1000 and the first to third mode changes according to the embodiment will be described in more detail. In the optical system 1000 according to the embodiment, the first lens group G1 and the fourth lens group G4 may be fixed, and the second lens group G2 and the third lens group G3 may be provided to be movable. The first lens group G1 may include three lenses, for example, the first to third lenses 110, 120, and 130, and the second lens group G2 may include two lenses, for example, the fourth and fifth lenses 140 and 150. In addition, the third lens group G3 may include two lenses, for example, the sixth and seventh lenses 160 and 170, and the fourth lens group G4 includes a single lens, for example, the eighth lens 180.

In the optical system 1000 according to the embodiment, the object-ide surface (seventh surface S7) of the fourth lens 140 may serve as an aperture stop, and the above-described optical filter 220 may be disposed between the fourth lens group G4 and the image sensor 200.

TABLE 1

| | | Radius of | Thickness (mm)/ | Reflective | Abbe | Focal length |
|---|---|---|---|---|---|---|
| Lens | Surface | curvature | Distance (mm) | Index | number | (mm) |
| Lens 1 | S1 | 7.007 | 2.667 | 1.535 | 19.24 | 11.320 |
| | S2 | −83.598 | 0.253 | | | |
| Lens 2 | S3 | 16.214 | 1.200 | 1.535 | 55.71 | 44.452 |
| | S4 | 49.225 | 1.937 | | | |
| Lens 3 | S5 | −39.218 | 0.600 | 1.851 | 40.10 | −4.058 |
| | S6 | 3.840 | dG12 | | | |
| Lens 4 | S7 | 4.081 | 2.035 | 1.553 | 71.68 | 5.419 |
| | S8 | −9.407 | 0.403 | | | |
| Lens 5 | S9 | −235.105 | 0.851 | 1.671 | 19.24 | −18.669 |
| | S10 | 13.429 | dG23 | | | |
| Lens 6 | S11 | −4.627 | 1.500 | 1.671 | 19.24 | 13.777 |
| | S12 | −3.503 | 0.300 | | | |
| Lens 7 | S13 | 14.078 | 0.600 | 1.535 | 55.71 | −5.627 |
| | S14 | 2.451 | dG34 | | | |
| Lens 8 | S15 | 22.164 | 1.637 | 1.671 | 19.24 | 9.649 |
| | S16 | −9.032 | 0.500 | | | |
| Filter | S17 | infinity | 0.210 | 1.523 | 54.5 | |
| | S18 | infinity | 0.289 | | | |
| Image | | infinity | 0.001 | | | |
| sensor | | | | | | |

TABLE 2

| Lens | Surface | Effective diameter (mm) |
|---|---|---|
| Lens 1 | S1 | 10.000 |
| | S2 | 9.725 |
| Lens 2 | S3 | 8.821 |
| | S4 | 8.058 |
| Lens 3 | S5 | 6.248 |
| | S6 | 5.627 |
| Lens 4 | S7 | 5.800 |
| | S8 | 5.685 |
| Lens 5 | S9 | 5.245 |
| | S10 | 4.699 |
| Lens 6 | S11 | 4.913 |
| | S12 | 4.982 |
| Lens 7 | S13 | 4.939 |
| | S14 | 5.706 |
| Lens 8 | S15 | 7.048 |
| | S16 | 7.017 |

TABLE 3

| Items | First mode (Mode 1) |
|---|---|
| dG12 (mm) | 5.462 |
| dG23 (mm) | 3.841 |
| dG34 (mm) | 0.714 |
| EFL_1 (mm) | −34.081 |
| EPD_1 | 4.734 |
| Magnification (First magnification) | 4.4 times |
| F-number | 2.10 |
| FOV (degree) | 21.26 |
| TTL (mm) | 25 |
| BFL (mm) | 1.000 |
| ImgH (mm) | 3.075 |

Tables 1 and 2 are a lens data when the optical system 1000 and the camera module including the same according to the embodiment operate in the first mode. In detail, Table 1 shows the radius of curvature on the optical axis OA of the first to eighth lenses 110, 120, 130, 140, 150, 160, 170 and 180, the center thickness of each lens, the center distance between the lenses, and the refractive index, Abbe number, and the size of the effective diameter (CA). Table 3 shows the effective focal length (EFL_1) and the size of the entrance pupil diameter (EPD_1), and the interval dG12 between the first lens group G1 and the second lens group G2, the interval dG23 between the second lens group G2 and the third lens group G3, and the interval dG34 between the third lens group G3 and the fourth lens group G4 for the first mode having the first magnification.

Referring to Table 1, the first lens 110 on the optical axis OA of the optical system 1000 according to the embodiment may have positive (+) refractive power. The first lens 110 may include a plastic material. In the optical axis OA, the first surface S1 of the first lens 110 may have a convex shape, and the second surface S2 may have a convex shape. The first lens 110 may have a convex shape on both sides of the optical axis OA. The first surface S1 may be an aspherical surface, and the second surface S2 may be an aspherical surface.

The second lens 120 may have a positive (+) refractive power on the optical axis OA. The second lens 120 may include a plastic material. In the optical axis OA, the third surface S3 of the second lens 120 may have a convex shape, and the fourth surface S4 may have a concave shape. The second lens 120 may have a meniscus shape convex from the optical axis OA toward the object side. The third surface S3 may be an aspherical surface, and the fourth surface S4 may be an aspherical surface.

The third lens 130 may have negative (−) refractive power on the optical axis OA. The third lens 130 may include a glass material. In the optical axis OA, the fifth surface S5 of the third lens 130 may have a concave shape, and the sixth surface S6 may have a concave shape. The third lens 130 may have a concave shape on both sides of the optical axis. The fifth surface S5 may be an aspherical surface, and the sixth surface S6 may be an aspherical surface. The third lens 130 may have a refractive index greater than about 1.6. The third lens 130 may have the largest refractive index among the lenses included in the first lens group G1. For example, the third lens 130 may have the largest refractive index among the plurality of lenses 100. In detail, the refractive index of the third lens 130 may be 1.75 or more or 1.8 or more.

The first lens group G1 and the second lens group G2 may have opposite refractive powers, for example, the first lens group G1 may have negative refractive power, and the second lens group G2 may have positive (+) refractive power.

The fourth lens 140 may have a positive (+) refractive power on the optical axis OA. The fourth lens 140 may include a glass material. In the optical axis OA, the seventh surface S7 of the fourth lens 140 may have a convex shape, and the eighth surface S8 may have a convex shape. The fourth lens 140 may have a shape in which both surfaces are convex. The seventh surface S7 may be an aspherical surface, and the eighth surface S8 may be an aspherical surface.

The fifth lens 150 may have negative (−) refractive power on the optical axis OA. The fifth lens 150 may include a plastic material. In the optical axis OA, the ninth surface S9 of the fifth lens 150 may have a concave shape, and the tenth surface S10 may have a concave shape. The fifth lens 150 may have a concave shape on both sides of the optical axis OA. The ninth surface S9 may be an aspherical surface, and the tenth surface S10 may be an aspherical surface. The ninth surface S9 may have at least one inflection point.

The sixth lens 160 may have a positive (+) refractive power on the optical axis OA. The sixth lens 160 may include a plastic material. In the optical axis OA, the eleventh surface S11 of the sixth lens 160 may have a concave shape, and the twelfth surface S12 may have a convex shape. The sixth lens 160 may have a meniscus shape convex from the optical axis OA toward the sensor side. The eleventh surface S11 may be an aspherical surface, and the twelfth surface S12 may be an aspherical surface.

The seventh lens 170 may have negative (−) refractive power on the optical axis OA. The seventh lens 170 may include a plastic material. In the optical axis OA, the thirteenth surface S13 of the seventh lens 170 may have a convex shape, and the fourteenth surface S14 may have a concave shape. The seventh lens 170 may have a meniscus shape convex from the optical axis OA toward the object side. The thirteenth surface S13 may be an aspherical surface, and the fourteenth surface S14 may be an aspherical surface. The thirteenth surface S13 and the fourteenth surface S14 may have at least one inflection point.

The eighth lens 180 may have positive (+) refractive power on the optical axis OA. The eighth lens 180 may include a plastic material. In the optical axis OA, the fifteenth surface S15 of the eighth lens 180 may have a convex shape, and the sixteenth surface S16 may have a convex shape. The eighth lens 180 may have a shape in which both sides are convex on the optical axis OA. The fifteenth surface S15 may be an aspherical surface, and the sixteenth surface S16 may be an aspherical surface.

The third lens group G3 and the fourth lens group G4 may have opposite refractive powers, for example, the third lens group G3 may have negative refractive power, and the four lens group G4 may have positive (+) refractive power. The second and third lens groups G2 and G3 may have opposite refractive powers. The first and fourth lens groups G1 and G4 may have opposite refractive powers.

In the optical system 1000 according to the embodiment, the values of the aspheric coefficients of the object-side surface and the sensor-side surface of the first to eighth lenses are shown in Table 4 below.

TABLE 4

| | Lens 1 | | Lens 2 | | Lens 3 | | Lens 4 | |
|---|---|---|---|---|---|---|---|---|
| | S1 | S2 | S3 | S4 | S5 | S6 | S7 | S8 |
| Y | 4.844 | 11.634 | 6.015 | 27.687 | −29.006 | 3.884 | 3.132 | −15.567 |
| Radius | | | | | | | | |
| K | −8.29E−02 | −5.51E+00 | −5.50E−01 | 9.33E+01 | 6.74E+01 | −6.32E−01 | −2.28E−01 | −2.24E+01 |
| A | 7.14E−05 | −1.65E−03 | −1.16E−03 | 4.16E−03 | 3.68E−03 | 1.98E−03 | 3.15E−04 | −3.00E−03 |
| B | −6.52E−06 | 3.10E−03 | 3.78E−03 | −4.04E−03 | −8.62E−03 | −6.72E−03 | 1.08E−05 | 7.56E−03 |
| C | 7.87E−05 | −2.38E−03 | −3.52E−03 | 1.18E−03 | 7.29E−03 | 6.77E−03 | 1.11E−04 | −1.03E−02 |
| D | −4.76E−05 | 1.03E−03 | 1.65E−03 | 2.23E−04 | −3.33E−03 | −3.47E−03 | −1.08E−04 | 8.93E−03 |
| E | 1.43E−05 | −2.66E−04 | −4.35E−04 | −2.30E−04 | 8.67E−04 | 9.10E−04 | 9.85E−05 | −4.77E−03 |
| F | −2.48E−06 | 4.22E−05 | 6.61E−05 | 6.06E−05 | −1.21E−04 | −7.67E−05 | −4.98E−05 | 1.59E−03 |
| G | 2.52E−07 | −4.01E−06 | −5.61E−06 | −7.41E−06 | 6.43E−06 | −1.67E−05 | 1.45E−05 | −3.21E−04 |
| H | −1.39E−08 | 2.10E−07 | 2.31E−07 | 3.99E−07 | 3.00E−07 | 4.32E−06 | −2.25E−06 | 3.58E−05 |
| J | 3.16E−10 | −4.63E−09 | −2.90E−09 | −5.41E−09 | −3.60E−08 | −2.76E−07 | 1.49E−07 | −1.68E−06 |
| | Lens 5 | | Lens 6 | | Lens 7 | | Lens 8 | |
| | S9 | S10 | S11 | S12 | S13 | S14 | S15 | S16 |
| Y | 11.182 | 4.863 | −4.582 | −2.861 | −5.150 | 3.493 | 27.497 | −6.671 |
| Radius | | | | | | | | |
| K | 1.41E+01 | 4.99E+00 | −8.81E+00 | −4.24E+00 | 3.75E+00 | −1.48E+01 | 2.98E+01 | −1.64E+00 |
| A | −1.13E−03 | 3.88E−03 | 4.32E−03 | −5.96E−03 | −7.48E−02 | −4.64E−02 | 1.07E−03 | −1.30E−03 |
| B | 7.26E−03 | 1.30E−03 | −2.88E−03 | −2.60E−03 | 2.94E−02 | 2.58E−02 | −3.11E−04 | 8.98E−04 |
| C | −1.12E−02 | −2.77E−03 | 3.77E−03 | 4.32E−03 | −3.27E−03 | −9.04E−03 | −1.23E−05 | −3.89E−04 |
| D | 9.97E−03 | 1.93E−03 | −2.38E−03 | −9.66E−04 | 2.42E−04 | 2.04E−03 | 9.15E−06 | 7.44E−05 |
| E | −5.46E−03 | −4.61E−04 | 7.08E−04 | −1.08E−03 | −2.28E−03 | −2.68E−04 | −3.21E−06 | −8.52E−06 |
| F | 1.85E−03 | −2.49E−04 | −4.14E−05 | 8.09E−04 | 1.72E−03 | 1.73E−05 | 8.07E−07 | 7.77E−07 |
| G | −3.78E−04 | 2.04E−04 | −2.92E−05 | −2.31E−04 | −5.35E−04 | −6.18E−07 | −1.10E−07 | −6.47E−08 |
| H | 4.22E−05 | −5.43E−05 | 7.05E−06 | 3.10E−05 | 7.88E−05 | 9.05E−08 | 7.35E−09 | 3.69E−09 |
| J | −1.95E−06 | 5.25E−06 | −4.84E−07 | −1.61E−06 | −4.51E−06 | −7.81E−09 | −1.91E−10 | −9.10E−11 |

TABLE 5

| Lens group | Lens | CT/ET |
|---|---|---|
| First lens group | Lens 1 | 4.438 |
| | Lens 2 | 1.399 |
| | Lens 3 | 0.392 |
| Second lens group | Lens 4 | 3.447 |
| | Lens 5 | 0.744 |
| Third lens group | Lens 6 | 1.269 |
| | Lens 7 | 0.365 |
| Fourth lens group | Lens 8 | 1.980 |

Referring to Table 5, the ratio CT/ET of the center thickness CT and the edge thickness ET of each lens of the plurality of lenses 100 may be different from each other, and the first lens may have the largest CT/ET value, and the seventh lens may have the smallest CT/ET value. The lenses having the CT/ET value of less than 1 may be three or less, and may include third, fifth, and seventh lenses, and the lenses having the values of the CT/ET value of 3 or greater may be two or more, and may include the first and fourth lenses. The difference between the Abbe number vd4 of the fourth lens 140 and the Abbe number vd5 of the fifth lens 150 included in the second lens group G2 may be 30 or more or 40 or more. Since the fourth lens 140 and the fifth lens 150 have the Abbe number difference as described above, the chromatic aberration change that occurs when the magnification is changed according to the movement M1 of the second lens group G2.

The difference between the Abbe number vd7 of the seventh lens 170 and the Abbe number vd6 of the sixth lens 160 included in the third lens group G3 may be 20 or more or 30 or more. Since the sixth lens 160 and the seventh lens 170 have the Abbe number difference as described above, the chromatic aberration change that occurs when the magnification is changed according to the movement M2 of the third lens group G3 is minimized and/or may perform an achromatic role by compensating.

The camera module according to the embodiment may acquire information about the subject at various magnifications. In detail, the driving member may control the positions of the second lens group G2 and the third lens group G3, and through this, the camera module may operate at various magnifications. For example, referring to FIGS. 1, 6 and 9 and Tables 1 to 5, the camera module including the optical system 1000 may operate on the first mode having a first magnification. The first magnification may be about 3 times to about 5 times. In detail, in an embodiment, the first magnification may be about 4.4 magnification.

In the first mode, each of the second lens group G2 and the third lens group G3 may be located at a location defined by a first position. When the initial position of each of the second lens group G2 and the third lens group G3 is the first position, the two lens groups G2 and G3 may not move. Alternatively, when the initial positions of each of the second lens group G2 and the third lens group G3 are different from the first position, the two lens groups G2 and G3 may be moved to the first position by the driving force of the driving member. Accordingly, each of the first to fourth lens groups G4 may be disposed at a set interval. For example, the second lens group G2 has a first interval dG12 from the first lens group G1, and the third lens group G3 has a second interval dG34 from the fourth lens group G4, and thus, the second lens group G2 may be located in a region spaced apart from the third lens group G3 by a third interval dG23. Here, the first to third intervals dG12, dG34, and dG23 may mean intervals between the lens groups on the optical axis OA.

When the camera module operates in the first mode, the optical system 1000 may have a total track length (TTL) value and a back focal length (BFL) value at the first position. Also, the optical system 1000 may have a first EFL (EFL_1) defined as a first effective focal length at the first position. Also, in the first mode, a FOV of the camera module may be less than about 25 degrees, and a F-number may be less than about 3.5. As shown in FIG. 5, it may be seen that the relative illuminance R1 at the first position (Position 1) may vary according to the height of the image sensor, and the relative illuminance at the periphery portion or edge of the image sensor is more than 40%.

The optical system 1000 may have excellent aberration characteristics as shown in FIGS. 6 and 9 in the first mode. In detail, FIG. 6 is a graph of the diffraction MTF characteristic of the optical system 1000 operating in the first mode (first magnification), and FIG. 9 is a graph of the aberration characteristic. The diffraction MTF characteristic graph is measured in units of about 0.307 mm from a spatial frequency of 0.000 mm to 3.150 mm. In the diffraction MTF graph, T represents the MTF change of the spatial frequency per millimeter of the tangential, and R represents the MTF change of the spatial frequency per millimeter of the radiation source. Here, the Modulation Transfer Function (MTF) depends on the spatial frequency of cycles per millimeter.

In the aberration graph of FIG. 9, longitudinal spherical aberration, astigmatic field curves, and distortion aberration are measured from left to right. In FIG. 6, the X-axis may represent a focal length (mm) and distortion (%), and the Y-axis may mean the height of an image sensor. In addition, the graph for spherical aberration is a graph for light in the wavelength bands of about 435 nm, about 486 nm, about 546 nm, about 587 nm, and about 656 nm, and the graph for astigmatism and distortion aberration is a graph for light in the wavelength band of 546 nm. In the aberration diagram of FIG. 9, it may be interpreted that the aberration correction function is better as each curve approaches the Y-axis and as shown in FIG. 9, in the optical system 1000 according to the embodiment, it may be seen that measured values are adjacent to the Y-axis in almost regions.

TABLE 6

| Item | Second mode (Mode 2) |
|---|---|
| dG12 (mm) | 0.300 |
| dG23 (mm) | 3.003 |
| dG34 (mm) | 6.714 |
| EFL_2 (mm) | −8.4482 |
| EPD_2 | 10.0 |
| Magnification (Second magnification) | 9.6 |
| F-number | 3.65 |
| FOV (degree) | 9.78 |
| TTL (mm) | 25 |
| BFL (mm) | 1.0 |
| ImgH (mm) | 3.075 |

Table 6 shows the effective focal length (EFL_2) and the size of the entrance pupil diameter (EPD_2), the interval dG12 between the first lens group G1 and the second lens group G2, the interval dG23 between the second lens group G2 and the third lens group G3, and the interval dG34 between the third lens group G3 and the fourth lens group G4 for the second mode having the second magnification. The camera module according to the embodiment may acquire information about the subject at various magnifications. In detail, the driving member may control the positions of the second lens group G2 and the third lens group G3, and through this, the camera module may operate at various magnifications. For example, referring to FIGS. 3, 8 and 11, and Tables 1 and 6, the camera module including the optical system 1000 may operate in the second mode having a second magnification. The second magnification may be about 8 magnifications to about 11 magnifications. In detail, the second magnification may be about 9.6 magnifications.

In the second mode, each of the second lens group G2 and the third lens group G3 may be located at a location defined by a second position. When the initial position of each of the second lens group G2 and the third lens group G3 is the second position, the two lens groups G2 and G3 may not move. On the other hand, when the initial positions of each of the second lens group G2 and the third lens group G3 are different from the second position, the two lens groups G2 and G3 may move to the second position by the driving force of the driving member. As shown in FIG. 5, it may be seen that the relative illuminance at the second position (Position 2) may be changed according to a height of the image sensor, and the relative illuminance at the periphery portion or edge of the image sensor is 95% or more. Accordingly, each of the first to fourth lens groups G4 may be disposed at a set interval. For example, the second lens group G2 has a first interval dG12 from the first lens group G1, and the third lens group G3 has a second interval dG34 from the fourth lens group G4, and thus, the second lens group G2 may be located in a region spaced apart from the third lens group G3 by a third interval dG23. Here, the first to third intervals dG12, dG34, and dG23 may mean intervals between the lens groups on the optical axis OA. The first interval dG12 of the first mode may be greater than the first interval dG12 of the second mode, and the second interval dG34 of the first mode may be smaller than the second interval dG34 of the second mode. Also, the third interval dG23 of the first mode may be greater than the third interval dG23 of the second mode.

When the camera module operates in the second mode, the optical system 1000 may have a total track length (TTL) value and a back focal length (BFL) value at the second position. Also, the optical system 1000 may have a second EFL (EFL_2) defined as a second effective focal length at the second position. In this case, the second EFL (EFL_2) may be larger than the first EFL (EFL_1). Also, in the second mode, the FOV of the camera module may be less than about 12 degrees, and the F-number may be less than about 6.5.

The optical system 1000 may have excellent aberration characteristics as shown in FIGS. 8 and 11 in the second mode. In detail, FIG. 8 is a graph of diffraction MTF characteristics of the optical system 1000 operating in the second mode (second magnification), and FIG. 11 is a graph of aberration characteristics. In the aberration graph of FIG. 8, longitudinal spherical aberration, astigmatic field curves, and distortion aberration are measured from left to right. In FIG. 7, the X-axis may indicate a focal length (mm) and distortion (%), and the Y-axis may indicate the height of an image sensor. In addition, the graph for spherical aberration is a graph for light in the wavelength bands of about 435 nm, about 486 nm, about 546 nm, about 587 nm, and about 656 nm, and the graph for astigmatism and distortion aberration is a graph for light in the wavelength band of 546 nm.

In the aberration diagram of FIG. 11, it may be interpreted that the aberration correction function is better as each curve approaches the Y-axis and as shown in FIG. 11, in the optical system 1000 according to the embodiment, it may be seen that measured values are adjacent to the Y-axis in almost regions.

TABLE 7

| Item | Third mode (Mode 3) |
|---|---|
| dG12 (mm) | 2.577 |
| dG23 (mm) | 2.921 |
| dG34 (mm) | 4.519 |
| EFL_3 (mm) | 6.701 |
| EPD_3 | 9.012 |
| Magnification (Third magnification) | 7 |
| F-number | 2.96 |
| FOV (degree) | 13.28 |
| TTL (mm) | 25 |
| BFL (mm) | 1.0 |
| ImgH (mm) | 3.075 |

Table 7 shows the effective focal length (EFL_3) and the size of the entrance pupil diameter (EPD_3), the distance between the first lens group G1 and the second lens group G2, the distance between the second lens group G2 and the third lens group G3, and the distance between the third lens group G3 and the fourth lens group G4 for the third mode having the third magnification.

The camera module according to the embodiment may acquire information about the subject at various magnifications. In detail, the driving member may control the positions of the second lens group G2 and the third lens group G3, and through this, the camera module may operate at various magnifications. For example, referring to FIGS. 2, 7 and 10, and Tables 1 and 7, the camera module including the optical system 1000 may operate in the third mode having a third magnification. The third magnification may be about 5 to about 8 magnifications. In detail, the third magnification may be about 7 magnifications.

In the third mode, each of the second lens group G2 and the third lens group G3 may be located at a location defined by a third position. The third position may be a region between the first and second positions. For example, a third position of the second lens group G2 may be located between the first and second positions of the second lens group G2 and a third position of the third lens group G3 may be located between the first and second positions of the third lens group G3. When the initial position of each of the second lens group G2 and the third lens group G3 is the third position, the two lens groups G2 and G3 may not move. Alternatively, when the initial positions of each of the second lens group G2 and the third lens group G3 are different from the third position, the two lens groups G2 and G3 may move to the third position by the driving force of the driving member. As shown in FIG. 5, it may be seen that the relative illuminance at the third position (Position 3) may be changed according to the height of the image sensor, and the relative illuminance at the periphery portion or edge of the image sensor is 75% or more. Accordingly, each of the first to fourth lens groups G4 may be disposed at a set interval. For example, the second lens group G2 has a first interval dG12 from the first lens group G1, and the third lens group G3 has a second interval dG34 from the fourth lens group G4, and thus, the second lens group G2 may be located in a region spaced apart from the third lens group G3 by a third interval dG23. Here, the first to third intervals dG12, dG34, and dG23 may mean intervals between the lens groups on the optical axis OA.

The first interval dG12 of the third mode may be smaller than the first interval dG12 of the first mode, and may be greater than the first interval dG12 of the second mode. The second interval of the third mode may be greater than the second interval dG34 of the first mode, and may be smaller than the second interval dG34 of the second mode. The third interval dG23 of the third mode may be smaller than the third interval dG23 of the first mode and the third interval dG23 of the second mode. When the camera module operates in the third mode, the optical system 1000 may have a total track length (TTL) value and a back focal length (BFL) value at the third position. Also, the optical system 1000 may have a third EFL (EFL_3) defined as a third effective focal length at the third position. In this case, the third EFL (EFL_3) may be larger than the first EFL (EFL_1) and may be smaller than the second EFL (EFL_2). Also, in the third mode, the FOV of the camera module may be less than about 17 degrees, and the F-number may be less than about 5.

The optical system 1000 may have excellent aberration characteristics as shown in FIGS. 7 and 10 in the second mode. In detail, FIG. 7 is a graph of a diffraction MTF characteristic of the optical system 1000 operating in the third mode (second magnification), and FIG. 10 is a graph of an aberration characteristic.

In the aberration graph of FIG. 10, longitudinal spherical aberration, astigmatic field curves, and distortion aberration are measured from left to right. In FIG. 7, the X-axis may represent a focal length (mm) and distortion (%), and the Y-axis may mean the height of an image sensor. In addition, the graph for spherical aberration is a graph for light in the wavelength bands of about 435 nm, about 486 nm, about 546 nm, about 587 nm, and about 656 nm, and the graph for astigmatism and distortion aberration is a graph for light in the wavelength band of 546 nm. In the aberration diagram of FIG. 10, it may be interpreted that the aberration correction function is better as each curve approaches the Y-axis and as shown in FIG. 10, in the optical system 1000 according to the embodiment, it may be seen that measured values are adjacent to the Y-axis in almost regions.

The optical system 1000 according to the embodiment may include various modes, and may provide an autofocus (AF) function for the subject by zooming the subject at a magnification corresponding to each mode. In the optical system 1000 according to the embodiment, the first lens group G1 closest to the object may be disposed at a fixed position without moving. Accordingly, TTLs may have the same value according to the first to third modes. In addition, in the optical system 1000, the fourth lens group G4 closest to the image sensor 200 may be disposed at a fixed position without moving. Accordingly, the BFLs may have the same value according to the first to third modes.

As another example, in the optical system 1000, at least one or two or more of the lenses included in the fixed group and the moving group may have a non-circular shape, or lenses of any one lens group may have a non-circular shape. Accordingly, an interval in which the second and third lens groups G2 and G3 are disposed between the first and fourth lens groups G1 and G4 may be structurally secured, and when the operation mode is changed, a movement M2 and M3 distance of the second and third lens group G2 and G3 may be significantly reduced. In detail, when the operation mode is changed, each of the second and third lens groups G2 and G3 may move within a maximum range of 6 mm or less, thereby improving power consumption characteristics. In addition, since the movement distance of each movement group is significantly reduced compared to the TTL, the position of the movement group can be more precisely controlled. For example, the maximum movement distance of the third lens group G3 may be greater than the maximum movement distance of the second lens group G2 and may be 6 mm or less, and the maximum movement distance of the second lens group G2 may be 5 mm or more. Each of the second and third lens groups G2 and G3 may be moved within a range of 5 mm to 6 mm.

TABLE 8

| Item | Embodiment |
|---|---|
| CA_G1max | 10.000 mm |
| CA_G2max | 5.800 mm |
| CA_G3max | 5.706 mm |
| CA_G4max | 7.048 mm |
| CA_G1min | 5.627 mm |
| CA_G2min | 4.699 mm |
| CA_G3min | 4.913 mm |
| CA_G4min | 7.017 mm |
| L_G1 | 6.657 mm |
| L_G2 | 3.289 mm |
| L_G3 | 2.400 mm |
| L_G4 | 1.637 mm |
| fG1 | −34.081 mm |
| fG2 | 6.701 mm |
| fG3 | −8.448 mm |
| fG4 | 9.649 mm |
| mG2 | 5.162 mm |
| mG3 | 6.000 mm |

TABLE 9

| Equation | | Embodiment |
|---|---|---|
| 1 | n_G1, n_G2, n_G3 > 1 | Satisfaction |
| 2 | CA_LAS7/CA_L1S1 < 0.7 | 0.58 |
| 3 | 2 < L1CT/L3CT < 5 | 4.45 |
| 4 | 1 < L10ET/L10CT < 4 | 1.32 |
| 5 | EFL_G1 < 0 | −34.081 |
| 6 | CRA < 6 | max 6 |
| 7 | Min_Relative illumination > 40 | 42.90 |
| 8 | (TTL/L_G1) > 3.5 | 3.76 |
| 9 | TTL/EPD Tele < 2.72 | 2.50 |
| 10 | 2 < L_Max_CT/L_Min_CT < 6 | 4.445 |
| 11 | 1 < L_Max_CA/L_Min_CA < 3 | 2.025 |
| 12 | CA_G1min < CA_G4max < CA_G1max | Satisfaction |
| 13 | 1 < L_G1/L_G2 < 3 | 2.024 |
| 14 | 1 < L_G1/L_G3 < 4 | 2.774 |
| 15 | 0.02 < d23/TTL < 0.5 | 0.077 |
| 16 | 5 < TTL/L_G2 < 12 | 7.601 |
| 17 | 20 < \|vd4-vd5\| | 52.44 |
| 18 | 20 < \|vd6-vd7\| | 36.47 |
| 19 | 1.6 < n3d | Satisfaction |
| 20 | 1 < LIR1/L3R2 < 2.5 | 1.825 |
| 21 | 1 < LIR1/L4R1 < 2.5 | 1.717 |
| 22 | 0 < L3R2/L4R1 < 2 | 0.941 |
| 23 | −1.5 < L1R1/L8R2 < 0 | −0.776 |
| 24 | 0.05 < m_G2/TTL < 0.5 | 0.206 |
| 25 | 0.05 < m_G3/TTL < 0.5 | 0.240 |
| 26 | 1.2 < m_G2/L_G2 < 2.5 | 1.570 |
| 27 | 2 < m_G3/L_G3 < 3.5 | 2.500 |
| 28 | 7 < L1_CT/ET:L3_CT/ET < 15 | 11.316 |
| 29 | 7 < L1_CT/ET:L7_CT/ET < 15 | 12.154 |
| 30 | 4 < dG12_model/dG34_model < 12 | 7.652 |
| 31 | 0.01 < dG12_mode2/dG34_mode2 <_0.7 | 0.045 |
| 32 | 1 < \|EFL_1/EFL_2\| < 10 | 5.086 |
| 33 | 2 < \|_1/EPD_1\| < 7 | 4.278 |
| 34 | 0.1 < EFL_2/EPD_2 < 3 | 0.744 |
| 35 | F#_Mode1 < 3.5 | Satisfaction |
| | F#_Mode2 < 3.5 | |
| 36 | 0 < \|TTL/EFL 1\| < 2 | 0.734 |
| 37 | 0.1 < TTL/EFL_2 < 5 | 3.731 |
| 38 | 1 < L_Max_CA/ImgH < 4 | 3.253 |
| 39 | 5 < TTL/ImgH < 10 | 8.131 |
| 40 | 15 < TTL/BFL < 30 | 25.000 |
| 41 | 2 < ImgH/BFL < 4 | 3.075 |
| 42 | 2 < dG1G4/TTL < 4 | 3.075 |

Table 8 is for the items of the above-described equations in the optical system and camera module according to the embodiment, and shows the focal length of each of the plurality of lenses 100, the total length and the focal lengths of the plurality of lens groups G1, G2, G3, and G4, and movement distances of the second and third lens groups G2 and G3. Table 9 shows the result values of Equations 1 to 42 of the optical system 1000 and the camera module according to the embodiment. Referring to Table 9, the optical system 1000 and the camera module according to the embodiment may satisfy at least one or two or more of Equations 1 to 42, or satisfy all

### Equations.

TABLE 10
CRA Data

| Field | Wide | Mid | Tele |
|---|---|---|---|
| 0 | 0.00 | 0.00 | 0.00 |
| 0.1 | 1.16 | 0.07 | 0.40 |
| 0.2 | 2.20 | 0.01 | 0.91 |
| 0.3 | 2.84 | 0.19 | 1.53 |
| 0.4 | 3.06 | 0.57 | 2.17 |
| 0.5 | 3.24 | 0.97 | 2.84 |
| 0.6 | 3.36 | 1.40 | 3.54 |
| 0.7 | 3.52 | 1.77 | 4.14 |
| 0.8 | 3.86 | 1.96 | 4.57 |
| 0.9 | 4.39 | 1.98 | 4.83 |
| 1 | 4.99 | 1.90 | 5.01 |

Table 10 is a table showing CRA values according to the first mode (Wide), the second mode (tele), and the third mode (mid) according to the field values (O˜1) of the image sensor in the camera module according to the embodiment.

TABLE 11

| Image_Height | Wide | Mid | Tele |
|---|---|---|---|
| 0.000 | 100.0 | 100.0 | 100.0 |
| 0.154 | 99.9 | 100.0 | 100.2 |
| 0.308 | 99.9 | 100.1 | 100.3 |
| 0.461 | 100.0 | 100.5 | 100.4 |
| 0.615 | 99.9 | 100.7 | 100.6 |
| 0.769 | 99.7 | 101.4 | 100.5 |
| 0.923 | 98.1 | 101.2 | 100.3 |
| 1.076 | 95.4 | 100.9 | 100.1 |
| 1.230 | 92.3 | 99.9 | 100.0 |
| 1.384 | 88.7 | 98.9 | 99.7 |
| 1.538 | 84.8 | 97.5 | 99.7 |
| 1.691 | 81.2 | 96.7 | 99.3 |
| 1.845 | 77.3 | 95.0 | 98.6 |
| 1.999 | 72.7 | 92.8 | 97.9 |
| 2.153 | 68.3 | 91.0 | 96.9 |
| 2.306 | 63.7 | 88.9 | 95.9 |
| 2.460 | 59.1 | 86.4 | 94.8 |
| 2.614 | 54.6 | 84.0 | 94.1 |
| 2.768 | 50.4 | 81.8 | 93.3 |
| 2.921 | 46.2 | 80.0 | 92.6 |
| 3.075 | 42.9 | 77.8 | 91.6 |

Table 11 shows the relative illuminance values according to the first mode (Wide), the second mode (tele), and the third mode (mid) according to the field values (O˜1) of the image sensor in the camera module according to the embodiment. Accordingly, the embodiment may provide an optical system having various magnifications by moving at least one lens group, and having excellent optical characteristics when various magnifications are provided. In detail, the embodiment may have a plurality of lenses 100 having a set number, a lens group having a refractive power, a set shape and focal length, a non-circular shape, and the like. In addition, the embodiment may provide an autofocus (AF) function for the subject at various magnifications by controlling the moving distance of the moving lens group. Accordingly, in the embodiment, a subject may be photographed at various magnifications using one camera module, and optical performance may be prevented from being deteriorated at each magnification. Referring to FIGS. 6 to 11, it may be seen that the optical system 1000 according to the embodiment has little or no change in optical characteristics even when the operation mode is changed to the first, second, and third modes. In detail, it may be seen that even when the magnification is changed within the range of the first magnification to the second magnification due to the position change of the second and third lens groups G2 and G3, there is little or no significant change in the MTF characteristic and the aberration characteristic. That is, it may be seen that the optical system 1000 according to the embodiment maintains excellent optical properties even when the magnification is changed within the first to second magnification range.

In the embodiment, the effective focal length (EFL) may be controlled by moving only some lens groups among the plurality of lens groups, and the moving distance of the moving lens group may be minimized. For example, in the embodiment, the moving lens group may have a moving distance of 6 mm or less. Accordingly, the optical system 1000 according to the embodiment can significantly reduce the moving distance of the lens group when the magnification is changed, and minimize power consumption required when the lens group is moved. In the optical system 1000 according to the embodiment, each of a plurality of lens groups may correct aberration characteristics or complement aberration characteristics changed by movement. Accordingly, the optical system 1000 according to the embodiment may minimize or prevent a change in chromatic aberration that occurs when a magnification is changed. In an embodiment, the magnification may be adjusted by moving a lens group other than the first lens group adjacent to the subject among the plurality of lens groups. Accordingly, the optical system 1000 may have a constant TTL value even when the lens group moves according to a change in magnification. Accordingly, the optical system 1000 and the camera module including the same may be provided with a slimmer structure.

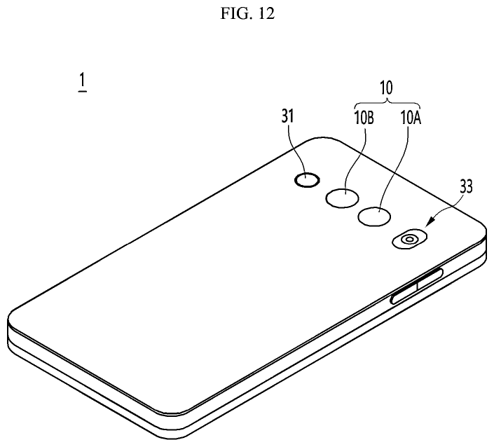

FIG. 12 is a diagram illustrating that a camera module according to an embodiment is applied to a mobile terminal. Referring to FIG. 12, the mobile terminal 1 may include the camera module 10 disclosed in the embodiment on the rear side. As another example, the mobile terminal 1 may include the camera module disclosed in the embodiment on the front side. The camera module 10 may include an image capturing function. In addition, the camera module 10 may include at least one of an auto focus function, a zoom function, and an OIS function.

The camera module 10 may process a still video image or an image frame of a moving image obtained by the image sensor 200 in a shooting mode or a video call mode. The processed image frame may be displayed on a display unit (not shown) of the mobile terminal 1 and stored in a memory (not shown). In addition, although not shown in the drawings, the camera module may be further disposed on the front of the mobile terminal 1. For example, the camera module 10 may include a first camera module 10A and a second camera module 10B. In this case, at least one of the first camera module 10A and the second camera module 10B may include the above-described optical system 1000. Accordingly, the camera module 10 may have a slim structure, and may photograph a subject at various magnifications.

The mobile terminal 1 may further include an autofocus device 31. The auto focus device 31 may include an auto focus function using a laser. The auto focus device 31 may be mainly used in a condition in which the auto focus function using the image of the camera module 10 is deteriorated, for example, in proximity of 10 m or less or in a dark environment. The autofocus device 31 may include a light emitting unit including a vertical cavity surface emitting laser (VCSEL) semiconductor device and a light receiving unit that converts light energy such as a photodiode into electrical energy.

The mobile terminal 1 may further include a flash module 33. The flash module 33 may include a light emitting device emitting light therein. The flash module 33 may emit light in a visible light wavelength band. For example, the flash module 33 may emit white light or light having a color similar to white light. However, the embodiment is not limited thereto, and the flash module 33 may emit light of various colors. The flash module 33 may be operated by a camera operation of a mobile terminal or by a user's control.

Features, structures, effects, etc. described in the above embodiments are included in at least one embodiment of the invention, and are not necessarily limited to only one embodiment. Furthermore, features, structures, effects, etc. illustrated in each embodiment can be combined or modified for other embodiments by those of ordinary skill in the art to which the embodiments belong. Accordingly, the contents related to such combinations and modifications should be interpreted as being included in the scope of the invention. In the above, the embodiment has been mainly described, but this is only an example and does not limit the invention, and those of ordinary skill in the art to which the invention pertains are not exemplified above in the range that does not depart from the essential characteristics of the present embodiment. It will be appreciated that various modifications and applications are possible. For example, each component specifically shown in the embodiment can be implemented by modification. And the differences related to these modifications and applications should be construed as being included in the scope of the invention defined in the appended claims.

1. An optical system comprising:
first to fourth lens groups disposed along an optical axis in a direction from an object side to a sensor side and including at least one lens, respectively,
wherein the first lens group and the fourth lens group have refractive powers of opposite signs,
wherein the second lens group and the third lens group have refractive powers of opposite signs,
wherein positions of the first and fourth lens groups are fixed, and
wherein a position of each of the second and third lens groups is movable in a direction of the optical axis,
wherein the optical system having the first to fourth lens groups is operated with magnifications according to changes in at least three modes according to a movement of each of the second lens group and the third lens group,
wherein a distance on the optical axis from a lens surface closest to the object side of the first lens group to a surface of an image sensor is TTL,
wherein a size of an entrance pupil diameter (EPD) of the optical system when operating at the highest magnification in an operation mode is EPD_Tele, and
wherein the following equation satisfies:
$$TTL / EPD\_Tele < 2.72 .$$

2. The optical system of claim 1,
wherein the first lens group includes first to third lenses sequentially disposed along the optical axis from the object side toward the sensor side,
wherein the second lens group includes fourth and fifth lenses sequentially arranged along the optical axis from the object side toward the sensor side,
wherein the third lens group includes sixth and seventh lenses sequentially arranged along the optical axis from the object side toward the sensor side, and
wherein the fourth lens group includes an eighth lens.

3. The optical system of claim 2,
wherein the first lens group has a negative (−) refractive power,
wherein the first lens has a positive (+) refractive power,
wherein the third lens has a negative (−) refractive power, and
wherein the fourth lens has positive (+) refractive power.

4. The optical system of claim 2,
wherein the third lens is formed of a glass material having an aspherical surface and having a refractive index of 1.75 or more, and
the fourth lens is formed of a glass material having an aspherical surface.

5. The optical system of claim 2,
wherein an object-side surface of the first lens has a convex shape on the optical axis toward the object side, and
wherein an object-side surface of the fourth lens has a convex shape on the optical axis toward the object side.

6. The optical system of claim 2,
wherein an object-side surface of the fifth lens, and an object-side surface and a sensor-side surface of the seventh lens have at least one inflection point.

7. The optical system of claim 6,
wherein a position of the inflection point on the object-side surface of the fifth lens is disposed in a range of 10% to 30% of an effective radius of the object-side surface of the fifth lens with respect to the optical axis.

8. The optical system of claim 6,
wherein the eighth lens has a shape in which an object-side surface and a sensor-side surface do not have inflection point.

9. An optical system comprising:
first to fourth lens groups disposed along an optical axis in a direction from an object side to a sensor side and including at least one lens, respectively,
wherein a number of lenses in the first lens group is greater than a number of lenses in the fourth lens group,
wherein the lenses of the first lens group are aligned along the optical axis, and,
wherein a first lens closest to the object among the lenses of the first lens group is a lens with a thickest center thickness,
wherein a sign of a refractive power of the first lens group is opposite to a sign of a refractive power of the fourth lens group,
wherein a lens closest to the sensor side among lenses of the first lens group has negative refractive power and has a sign opposite to a refractive power of a lens closest to the object side among lenses of the second lens group,
wherein positions of the first and fourth lens groups are fixed,
wherein positions of the second and third lens groups are movable in a direction of the optical axis,
wherein the optical system having the first to fourth lens groups is operated with magnifications according to changes in at least three modes according to a movement of each of the second lens group and the third lens group,
EFL_G1 is an effective focal length of the first lens group, and
wherein the following equation satisfies: EFL_G1<0.

10. The optical system of claim 9,
when the second and third lens groups are positioned at a first position, the optical system has a first effective focal length, and
when the second and third lens groups are positioned at a second position different from the first position, the optical system has a second effective focal length greater than the first effective focal length.

11. The optical system of claim 10, wherein
m_G2 is a movement distance when the second lens group moves from the first position to the second position or from the second position to the first position,
TTL (Total track length) is a distance on the optical axis from an object-side surface of a lens closest to the object in the first lens group to an upper surface of an image sensor, and
wherein the following equation satisfies:
$$0.05 < m\_G2 / TTL < 0.5 .$$

12. The optical system of claim 10, wherein
m_G3 is a movement distance when the third lens group moves from the first position to the second position or from the second position to the first position, and
TTL (Total Track Length) is a distance on the optical axis from the object-side surface of a lens closest to the object in the first lens group to an upper surface of an image sensor, and
wherein the following equation satisfies:
$$0.05 < m\_G3 / TTL < 0.5 .$$

13. The optical system of claim 9,
wherein a maximum movement distance of the third lens group is greater than a maximum movement distance of the second lens group.

14. The optical system of claim 13,
wherein the maximum movement distance of third lens group is 6 mm or less, and the maximum movement distance of the second lens group is 5 mm or more.

15. The optical system of claim 9, wherein
Min_Relative illumination is a value having a lowest relative illuminance value at each magnification, and wherein the following equation satisfies:
Min_Relative illumination>40.

16. The optical system of claim 9, wherein
CRA is a chief ray incidence angle of light incident to an image sensor, and
wherein the following equation satisfies:
$$CRA < 6 .$$

17. The optical system of claim 9,
wherein the fourth lens group consists of one lens, the first, second, and third lens groups consist of two or more lenses, and
CA_L4S7 is an effective diameter of an object-side surface of the lens closest to the first lens group among the lenses of the second lens group,
CA_L1S1 is an effective diameter of an object-side surface of the first lens, and
wherein the following equation satisfies:
$$CA\_L4S7 / CA\_L1S1 < 0.7 .$$

18. The optical system of claim 9,
wherein the first lens group includes second and third lenses spaced apart from each other along the optical axis on a sensor side of the first lens,
wherein the second lens group includes fourth and fifth lenses aligned with the optical axis,
wherein the third lens group includes sixth and seventh lenses aligned with the optical axis,
wherein the fourth lens group includes an eighth lens,
vd4 is an Abbe number of the fourth lens and vd5 is an Abbe number of the fifth lens,
vd6 is an Abbe number of the sixth lens, and vd7 is an Abbe number of the seventh lens, and
wherein the following equation satisfies:
$$20 < \vert vd 4 - vd 5 \vert$$
$$and$$
$$20 \text{<\textbar} vd 6 - vd 7 \vert .$$

19. The optical system of claim 9, wherein
dG1G4 is a distance between a lens surface closest to the sensor side of the first lens group and a lens surface closest to the object side of the fourth lens group on the optical axis, and
TTL is a distance on the optical axis from a lens surface closest to the object side of the first lens group to an upper surface of an image sensor, and
wherein the following equation satisfies: dG1G4<TTL,
wherein a distance on the optical axis from a vertex of a sensor-side surface of a lens closest to the image sensor to the upper surface of the image sensor is BFL,
wherein ½ of a total diagonal length of an effective region of the image sensor is ImgH,
wherein the following equation satisfies:
$$2 < ImgH / BFL < 4. \qquad Equation$$

20. A camera module comprising:
an optical system and a driving member,
wherein the optical system includes an optical system according to claim 1, and
wherein the driving member is driven in a direction of the optical axis with respect to each position of the second and third lens groups.
